(19) United States
(12) Patent Application Publication
(10) Pub. No.: US 2026/0105398 A1
(43) Pub. Date: Apr. 16, 2026

(54) Method and Computing System for Assessing Dynamic Risk for Strategic Planning of Assets and Systems

(71) Applicant: ABB Schweiz AG, Baden (CH)

(72) Inventors: Vaishnavi Seetharama, Bengaluru (IN); Ajinkya Tathe, Bangalore (IN); Jeevan Jadhav, Bangalore (IN); Anindya Chatterjee, Bengaluru (IN); Stacey Jones, Lake Jackson, TX (US)

(73) Assignee: ABB Schweiz AG, Baden (CH)

(21) Appl. No.: 19/353,776

(22) Filed: Oct. 9, 2025

(30) Foreign Application Priority Data
Oct. 10, 2024 (IN) 202441077090

(51) Int. Cl. G06Q 10/0637; G06Q 10/0635

(52) U.S. Cl. CPC G06Q 10/0637; G06Q 10/0635

(57) ABSTRACT

A method for assessing dynamic risk for strategic planning of assets includes receiving a risk score of failure modes of assets and event data related to assets; determining a first score indicating aggregated criticality of assets based on risk score of failure modes of assets; determining a second score indicating aggregated dynamic criticality of assets based on asset level amplified risk score of failure modes of assets; determining the asset level second score indicating aggregated dynamic criticality of assets; assessing assess dynamic risk of assets based on asset level first score and asset level second score, and providing corrective action recommendations related to assets.

### CROSS-REFERENCE TO RELATED APPLICATIONS

The instant application claims priority to Indian Patent Application number 202441077090, filed Oct. 10, 2024, which is incorporated herein in its entirety by reference.

### FIELD OF THE DISCLOSURE

The present disclosure relates to Failure Mode, Effect and Criticality Analysis (FMECA) and, more particularly, to a method and computing system for assessing dynamic risk for strategic planning of assets and systems.

### BACKGROUND OF THE INVENTION

Criticality Analysis is a vital process in various industries, ranging from refineries to healthcare and manufacturing. Its significance lies in its ability to systematically assess and prioritize potential failure modes within complex systems, ensuring the safety, reliability, and efficiency of these systems. Criticality analysis helps organizations identify not only what could go wrong but also the consequences of those failures on both operational performance and safety. By meticulously analyzing failure modes and their criticality, criticality analysis empowers decision-makers to allocate resources efficiently for preventive measures, maintenance, and risk mitigation strategies. This proactive approach not only enhances product and system reliability but also minimizes downtime, reduces costly breakdowns, and, most importantly, safeguards human lives. In essence, criticality analysis is a cornerstone of risk management, providing a structured framework to optimize system performance while prioritizing safety, ultimately leading to improved product quality and customer satisfaction.

Failure Mode, Effect and Criticality Analysis (FMECA) is a systematic approach for proactively assessing the risks associated with an asset. It involves identifying potential failure modes within a system, analyzing their effects on critical functions and overall safety, and prioritizing them based on their likelihood and severity. By understanding these risks, FMECA enables informed decision-making regarding maintenance, design modifications, and operational procedures to mitigate potential issues and ensure the asset's reliability.

### BRIEF SUMMARY OF THE INVENTION

In view of the foregoing, there is a need to provide dynamic FMECA for daily maintenance, planning and execution of complex systems. In one aspect, the present disclosure describes a method of assessing dynamic risk for strategic planning of one or more assets. The method comprises receiving, by a processor associated with a computing system, a risk score of each of one or more failure modes of each of one or more assets and event data related to each of the one or more assets from at least one input source associated with each of the one or more assets. Further, the method comprises determining an asset level first score indicating aggregated criticality of each of the one or more assets based on the risk score of each of the one or more failure modes of each of the one or more assets. Thereafter, the method comprises determining an asset level amplified risk score of each of the one or more failure modes based on the risk score of each of the one or more failure modes of each of the one or more assets and the event data related to each of the one or more assets. Furthermore, the method comprises determining an asset level second score indicating aggregated dynamic criticality of each of the one or more assets based on the asset level amplified risk score of each of the one or more failure modes of each of the one or more assets. Thereafter, the method comprises assessing dynamic risk of each of the one or more assets based on the asset level first score and the asset level second score. Finally, the method comprises one or more corrective action recommendations related to the one or more assets based on the assessment.

Further, disclosed herein is a computing system for assessing dynamic risk for strategic planning of one or more assets. The computing system comprises a processor and a memory. The memory is communicatively coupled to the processor and stores processor-executable instructions, which on execution, cause the processor to receive a risk score of each of one or more failure modes of each of one or more assets and event data related to each of the one or more assets from at least one input source associated with each of the one or more assets. Further, the processor determines an asset level first score indicating aggregated criticality of each of the one or more assets based on the risk score of each of the one or more failure modes of each of the one or more assets. Thereafter, the processor determines an asset level amplified risk score of each of the one or more failure modes based on the risk score of each of the one or more failure modes of each of the one or more assets and the event data related to each of the one or more assets. Furthermore, the processor determines an asset level second score indicating aggregated dynamic criticality of each of the one or more assets based on the asset level amplified risk score of each of the one or more failure modes of each of the one or more assets. Thereafter, the processor assess dynamic risk of each of the one or more assets based on the asset level first score and the asset level second score. Finally, the processor provides one or more corrective action recommendations related to the one or more assets based on the assessment.

Disclosed herein is a method of assessing dynamic risk for strategic planning of a system associated with one or more assets. The method comprises receiving, by a processor associated with a computing system, at least one of a risk score of each of one or more failure modes of each of one or more assets associated with each of the one or more systems, a risk score of each of one or more failure modes of each of one or more systems, asset level first score indicating criticality of each of the one or more failure modes of each of the one or more assets, asset level second score indicating dynamic criticality of each of the one or more assets, event data related to the each of the one or more systems and event data related to the each of the one or more assets, from at least one input source associated with the system. Further, the method comprises determining a system level first score indicating aggregated criticality of each of the one or more systems based on at least one of, the risk score of each of the one or more failure modes of each of the one or more systems, and one of the risk score of each of the one or more failure modes of each of the one or more assets and the asset level first score. Thereafter, the method comprises determining a system level amplified risk score of each of the one or more failure modes based on the risk score of each of the one or more failure modes of each of the one or more systems and the event data related to each of the one or more systems. Furthermore, the method comprises determining a system level second score indicating aggregated dynamic criticality of each of the one or more systems based on at least one of, the system level amplified risk score of each of the one or more failure modes of each of the one or more systems, and one of an asset level amplified risk score of each of the one or more failure modes of each of the one or more assets or the asset level second score. The asset level amplified risk score is determined based on the risk score of each of the one or more failure modes of each of the one or more assets and the event data related to each of the one or more assets. Thereafter, the method comprises assessing dynamic risk of each of the one or more systems based on the system level first score and the system level second score. Finally, the method comprises providing one or more corrective action recommendations related to the one or more systems based on the assessment.

Further, disclosed herein is a computing system for dynamic risk of a system associated with one or more assets for strategic planning. The computing system comprises a processor and a memory. The memory is communicatively coupled to the processor and stores processor-executable instructions, which on execution, cause the processor to receive at least one of a risk score of each of one or more failure modes of each of one or more assets associated with each of the one or more systems, a risk score of each of one or more failure modes of each of one or more systems, asset level first score indicating criticality of each of the one or more failure modes of each of the one or more assets, asset level second score indicating dynamic criticality of each of the one or more assets, event data related to the each of the one or more systems and event data related to the each of the one or more assets, from at least one input source associated with the system. Further, the processor determines a system level first score indicating aggregated criticality of each of the one or more systems based on at least one of, the risk score of each of the one or more failure modes of each of the one or more systems, and one of the risk score of each of the one or more failure modes of each of the one or more assets and the asset level first score. Thereafter, the processor determines a system level amplified risk score of each of the one or more failure modes based on the risk score of each of the one or more failure modes of each of the one or more systems and the event data related to each of the one or more systems. Furthermore, the processor determines a system level second score indicating aggregated dynamic criticality of each of the one or more systems based on at least one of, the system level amplified risk score of each of the one or more failure modes of each of the one or more systems, and one of an asset level amplified risk score of each of the one or more failure modes of each of the one or more assets or the asset level second score. The asset level amplified risk score is determined based on the risk score of each of the one or more failure modes of each of the one or more assets and the event data related to each of the one or more assets. Thereafter, the processor assess dynamic risk of each of the one or more systems based on the system level first score and the system level second score. Finally, the processor provides one or more corrective action recommendations related to the one or more systems based on the assessment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE SEVERAL VIEWS OF THE DRAWING(S)

FIG. 1A is a diagram of an exemplary architecture for assessing dynamic risk for strategic planning of one or more assets, in accordance with some embodiments of the present disclosure.

FIG. 1B is an exemplary graph indicating criticality of multiple assets, in accordance with some embodiments of the present disclosure.

FIGS. 2A and 2B are diagrams of an exemplary architecture for assessing dynamic risk for strategic planning of a system associated with one or more assets, in accordance with some embodiments of the present disclosure.

FIG. 2C is a diagram of an exemplary fluid power system, in accordance with some embodiments of the present disclosure.

FIG. 3 is a detailed block diagram of a computing system for assessing dynamic risk for strategic planning of one or more assets, in accordance with some embodiments of the present disclosure.

FIG. 4 is a detailed block diagram of a computing system for assessing dynamic risk for strategic planning of a system associated with one or more assets, in accordance with some embodiments of the present disclosure.

FIG. 5 is a flowchart illustrating a method of assessing dynamic risk for strategic planning of one or more assets, in accordance with some embodiments of the present disclosure.

FIG. 6 is a flowchart illustrating a method of assessing dynamic risk for strategic planning of a system associated with one or more assets, in accordance with some embodiments of the present disclosure.

FIG. 7 is a block diagram of an exemplary computer system for implementing embodiments consistent with the present disclosure.

### DETAILED DESCRIPTION OF THE INVENTION

As outlined in the background section, the model-based approach which is an existing technique provides diagnostic alerts and symptoms are not consolidated due to its nature of reporting deviations which apparently may be seen as small/insignificant deviations. Also, the existing FMECA is static in nature, which may not be so fruitful in daily maintenance, planning and execution. Further, in most of existing implementation of predictive maintenance, the existing system lacks task prioritization method to tackle multiple events generated from predictive maintenance applications. However, depending on the criticality of that affected failure mode and inherent risk perception will provide an opportunity to normalize the risk estimates and utilize it for regular strategic planning of failure avoidance. The present disclosure proposes to make Failure Mode, Effect and Criticality Analysis (FMECA) dynamic considering all the abnormalities and cumulative effect on differential risk estimate will bring value for them to improve their maintenance planning function. The existing A Performance Monitoring (APM) system is used to improve maintenance planning function. The present disclosure proposes dynamic FMECA that utilizes event data such as alerts and warning notification data from APM systems represents a significant advancement in risk assessment and system reliability. By incorporating real-time event data, the present disclosure enables organizations to continuously monitor and adapt to evolving conditions, ensuring the utmost safety and efficiency of complex systems. The importance of dynamic FMECA lies in its ability to detect and highlight the change in the inherited risks due to abnormalities, degradation of health or performance of the assets and systems. This will enable dynamic prioritization of any mitigative activities due consideration weightage to the scale of criticality of the machine and deviation quantum. The present disclosure not only minimizes downtime and costly disruptions but also enhances predictive maintenance strategies, scheduling resource allocation and reducing overall operational costs. Moreover, dynamic FMECA empowers industries such as, without limiting to, process industries, manufacturing, and healthcare to proactively address emerging issues, prevent unplanned stoppages, and ultimately deliver a higher level of reliability and performance of the assets and the systems. In a world increasingly reliant on data-driven decision-making, dynamic FMECA, which assists in analyzing the changing criticality of vital assets is a crucial tool for ensuring the continued safety and functionality of complex systems.

According to the present disclosure, a computing system which may be configured to perform dynamic FMECA, may receive a risk score of each of one or more failure modes of each of one or more assets and event data related to each of the one or more assets from at least one input source associated with each of the one or more assets. As discussed above, APM system may provide the event data which may include, without limitation, real-time and/or near real-time event data. Further, the computing system may determine an asset level first score indicating aggregated criticality of each of the one or more assets based on the risk score of each of the one or more failure modes of each of the one or more assets. Upon determining the asset level first score, the computing system may determine an asset level amplified risk score of each of the one or more failure modes based on the risk score of each of the one or more failure modes of each of the one or more assets and the event data related to each of the one or more assets. The asset level amplified risk score provides a real-time understanding of condition of each of the one or more failure modes. Thereafter, the computing system may determine an asset level second score indicating aggregated dynamic criticality of each of the one or more assets based on the asset level amplified risk score of each of the one or more failure modes of each of the one or more assets. Furthermore, the computing system may assess dynamic risk of each of the one or more assets based on the asset level first score and the asset level second score. Finally, the computing system may provide one or more corrective action recommendations related to the one or more assets based on the assessment. The strategic planning may be a systematic approach to identifying, analyzing, and prioritizing potential failure modes in the assets and the systems. The strategic planning is a proactive measure designed to prevent failures and minimize their impact on operations of the assets and the systems. The present disclosure also evaluates dynamic risk of a system associated with one or more assets for strategic planning, which is discussed below in detail.

The present disclosure assesses dynamic risk of assets and systems based on real-time and/or near-real time event data which helps in accurately performing the risk assessment of the assets and the systems. The present disclosure helps in preventing unexpected equipment failures by proactively identifying change in the criticality of failure modes and taking preventive maintenance actions as the event data is used to determine the asset level second score. Further, the present disclosure performs risk assessment of the one or more assets and the one or more systems considering safety and environmental impact of the one or more assets and the one or more systems. The present disclosure helps in improving the safety by detecting safety-critical failures in advance and taking necessary precautions. Further, the present disclosure helps in proactively identifying the change in the criticality of the failure mode and taking necessary actions to mitigate the failure modes, which help in reducing resources and additional cost caused by critical failure modes. In other words, the probable wastage resource and costs which may be incurred if the machine is unfocused is reduced as the present disclosure assess dynamic risk. Efficiently using dynamic FMECA and proactively addressing the criticality will address the environmental impacts that may occur if the failures are met by the assets. The present disclosure may help in extending the lifespan of heavy machinery by using dynamic FMECA.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

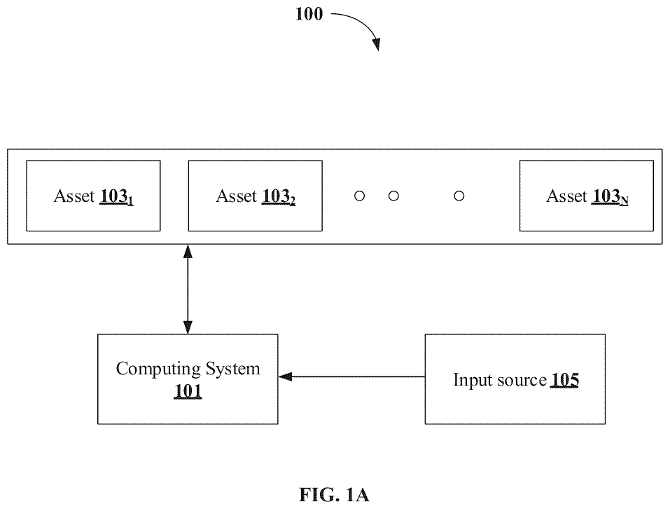

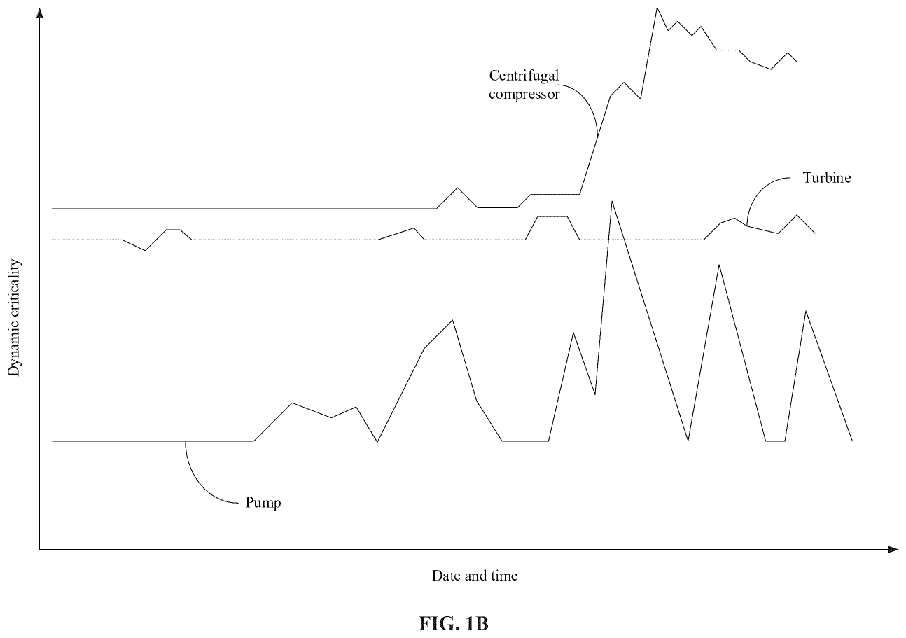

FIG. 1A shows an exemplary architecture for assessing dynamic risk for strategic planning of one or more assets, in accordance with some embodiments of the present disclosure.

Exemplary environment 100 comprises a computing system 101 and asset 1031 to asset 103N (also referred as one or more assets 103 or assets 103). In an embodiment, the computing system may be associated with the one or more assets 103 using a communication network (not shown in figure). As an example, the communication network may be a wired communication network, a wireless communication network or a combination of both the wired communication network and the wireless communication network, which enables the connection of the one or more assets 103 and the computing system 101 for communication. As an example, the computing system 101 may include, without limitation, any device such as, but not limited to, mobile phones, smartphones, laptops, cloud computing, and Personal Computers (PCs). In some embodiments, the computing system 101 may be an existing computing system which was used for performing Failure Mode Effect and Criticality Analysis (FMECA) of the one or more assets 103 using conventional technique. In some embodiments, the computing system 101 may be an upgraded version of the existing computing system. As an example, the one or more assets 103 may include, without limitation, any electronic system or any mechanical system used in an industry. As an example, the one or more assets 103 in a wind turbine system may include, without limitation, compressor, combustor turbine, generators and transformers. In an embodiment, the one or more assets 103 and the computing system 101 may be associated with an Asset Performance Monitoring (APM) system (not shown in figure) which may be used to track the performance of the one or more assets 103.

In an embodiment, the computing system 101 may be configured to receive a risk score of each of one or more failure modes of each of the one or more assets 103 and event data related to each of the one or more assets 103 from at least one input source 105 associated with each of the one or more assets 103. In an embodiment, the one or more failure modes may include a specific way in which the asset may fail to perform its intended function which may include, without limitation, primary function and secondary function. For example, malfunctioning of the asset, performance issue of the asset, degradation of the asset and the like, which may prevent the asset to perform its intended function. As an example, if the asset is a compressor, the one or more failure modes may include, without limitation, thrust bearing failure, Non-Drive End (NDE), Dry Gas Seal (DGS) failure, Drive End (DE) bearing failure and DE DGS failure. In an embodiment, each of one or more failure modes may be assigned with the risk score which may be determined based on severity of the failure mode, occurrence of the failure mode and detection of the failure mode. In some embodiments, the risk score may be determined using the below Equation 1:

$$Risk Score = \frac{Severity \times Occurance}{\sqrt{Detection}} \qquad Equation 1$$

Equation 1 provided above is intended as an illustrative example and should not be construed as a limitation of the present disclosure.

In an embodiment, the severity of the failure mode, the occurrence of the failure mode and the detection of the failure mode may be determined periodically. As an example, the values may be determined by a Subject Matter Expert (SME), a back-end computing system and the like. Considering the above example of the compressor, the severity of the failure mode, the occurrence of the failure mode, the detection of the failure mode and the risk score of each failure mode of the compressor are shown below:

TABLE A

| Failure mode | Severity | Occurrence | Detection | Risk score |
|---|---|---|---|---|
| FM1 | 120 | 200 | 500 | 1073 |
| FM2 | 130 | 220 | 520 | 1254 |
| FM3 | 180 | 250 | 550 | 1919 |
| FM4 | 190 | 280 | 550 | 2268 |

The values provided in the above table “Table A” is intended as an illustrative example and should not be construed as a limitation of the present disclosure. The risk score in Table A above is determined using the equation discussed above. In some embodiments, the risk score may be determined using any other well-known techniques.

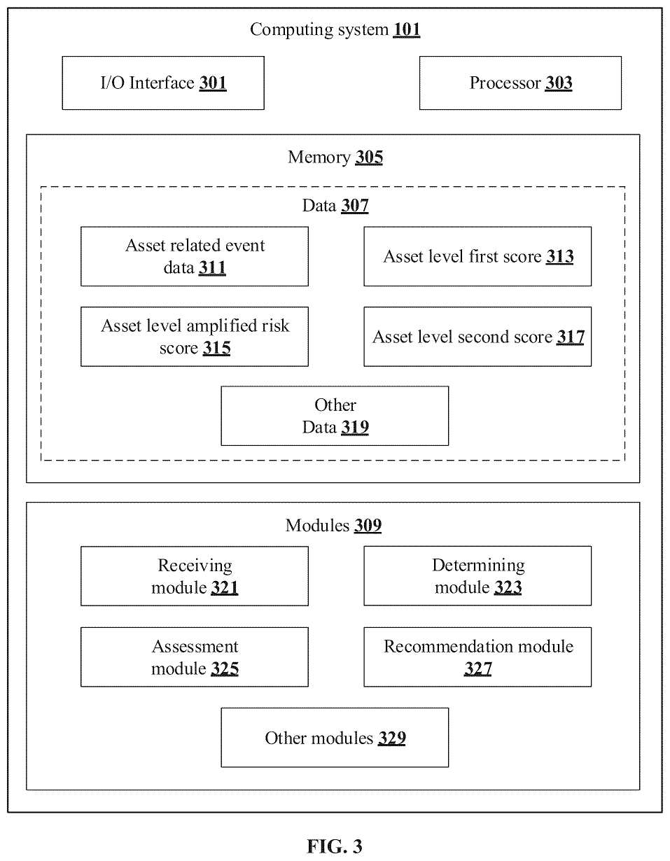

In an embodiment, the event data may be generated based on at least one of analytics information related to the one or more assets 103 received from analytics data sources, alerts and warnings related to the one or more assets 103 received from control systems, and notifications related to the one or more assets 103 received from Enterprise Resource Planning (ERP) systems. In an embodiment, the even data may indicate at least one of a plurality of characteristics associated with each of one or more events related to corresponding one or more assets 103. In an embodiment, the event data may be received from the APM system associated with the computing system 101 and the one or more assets 103. The event data is discussed in detail in FIG. 3 of the present disclosure. The at least one input source 105 associated with each of the one or more assets 103 may include, without limitation, the APM system for receiving the event data and computing system 101 to receive the risk score of each of the failure modes of each of the one or more assets 103.

In an embodiment, upon receiving the risk score and the event data, the computing system 101 may be configured to determine an asset level first score indicating aggregated criticality of each of the one or more assets 103 based on the risk score of each of the one or more failure modes of each of the one or more assets 103. In an embodiment, the computing system 101 may normalize the risk score of each of the one or more failure modes of each of the one or more assets 103. Normalization is performed to standardize the risk score of each of the one or more failure modes of each of the one or more assets 103. In an embodiment, the normalization is performed by dividing maximum risk score with each of the risk score. Considering the risk score values from Table A, the normalized values of the risk score are provided below:

TABLE B

| Failure mode | Risk score | Normalized value |
|---|---|---|
| FM1 | 1073 | 0.0 |
| FM2 | 1254 | 0.2 |
| FM3 | 1919 | 1.0 |
| FM4 | 2268 | 1.4 |

The values provided in the above table “Table B” are intended as an illustrative example and should not be construed as a limitation of the present disclosure.

In an embodiment, upon normalizing the risk score, the computing system 101 may determine a weightage for the normalized risk score of each of the one or more failure modes of each of the one or more assets 103 using a first predefined technique. As an example, the first predefined technique may be a polynomial equation in which the normalized value is used to determine the weightage. As an example, the weightage may be determined using the below polynomial equation i.e., Equation 2:

$$Weightage = A 1 {x}^{3} + A 2 {x}^{2} + A 3 x + A 4 \qquad Equation 2$$

Where: A1, A2, A3 and A4 may be predefined constant values which may be derived from an experimentation process. As an example, the range of ‘a’ may be −5 to −3, ‘A2’ may be −3 to 5, ‘A3’ may be −5 to 2 and ‘A4’ may be −5 to −5.

The Equation 2 provided above is intended as an illustrative example and should not be construed as a limitation of the present disclosure. Considering the normalized value in Table B, the weightage value determined for each of the one or more failure modes of the compressor are provided below:

TABLE C

| Failure mode | Normalized value | Weightage |
|---|---|---|
| FM1 | 0.0 | 0.00 |
| FM2 | 0.2 | 0.12 |
| FM3 | 1.0 | 0.50 |
| FM4 | 1.4 | 0.29 |

The values provided in the above table “Table C” are intended as an illustrative example and should not be construed as a limitation of the present disclosure.

In an embodiment, upon determining the weightage, the computing system 101 may determine the asset level first score based on the risk score of the one or more failure modes and cumulative weightage score of the each of the one or more failure modes of each of the one or more assets 103. The cumulative weightage score may be obtained by aggregating weightage of the each of the one or more failure modes of each of the one or more assets 103.

In an embodiment, upon determining the asset level first score, the computing system 101 may be configured to determine an asset level amplified risk score of each of the one or more failure modes based on the risk score of each of the one or more failure modes of each of the one or more assets 103 and the event data related to each of the one or more assets 103. In an embodiment, the computing system 101 may determine at least one weightage value for each of the one or more assets 103 based on the event data and a plurality of characteristics associated with each of one or more events related to the corresponding one or more assets 103. The plurality of characteristics may include, without limitation, type of event, type of notification, time at which the notification was generated, open events which are not resolved, and number of notifications generated for each event. The type of event may include, without limitation, rule based, condition indicator, and unsupervised event. The type of notification may include, without limitation, an alert and a warning. Further, the computing system 101 may determine an amplification factor for each of the one or more failure modes of each of the one or more assets 103 based on the at least one weightage value using a second predefined technique. The method of determining the at least one weightage value and the amplification factor is discussed in FIG. 3 of the present disclosure. The second predefined technique may be an equation in which the at least one weightage value is used to determine the amplification factor. As an example, the amplification factor may be determined using below Equation 3:

$$Amplification factor ( AF ) : AF = 1 + a * ( f ( w 1 , w 2 , b ) ) - c \qquad Equation 3$$

As an example, the equation for determining the amplification factor derived from above equation is provided below:

$$AF = 1 + a * \frac{1}{1 + b * {e}^{( w 1 * w 2 )}} - c$$

Where: w1 is first weight which may be determined based on the type of the event. As an example, the event type 1 is more severe than the event type 2, event type 3, event type 4 and event type 6; w2 is second weight which may be determined based on time of notification; a, b and c are predefined constant values which may be derived from an experimentation process. As an example, the range of ‘a’ may be 0-20, ‘b’ may be 0-5, and ‘c’ may be −2-5.

Equation 3 is intended as an illustrative example and should not be construed as a limitation of the present disclosure. Thereafter, the computing system 101 may determine the asset level amplified risk score of each of the one or more failure modes of each asset in the one or more assets 103 based on the risk score of each of the one or more failure modes of each of the one or more assets 103 and the corresponding amplification factor. The amplification factor may be multiplied with the risk score of each of the one or more failure modes to obtain the asset level amplified risk score of each of the one or more failure modes. Considering the risk score values in the Table A, the amplification factor, the amplified risk score for the corresponding one or more failure modes are shown in Table D below:

TABLE D

| | | Amplification | |
|---|---|---|---|
| Failure mode | Risk score | factor | Amplified risk score |
| FM1 | 1073 | 1.50 | 1610 |
| FM2 | 1254 | 1.50 | 1881 |
| FM3 | 1919 | 1.25 | 2399 |
| FM4 | 2268 | 1.00 | 2268 |

The values provided in the above table “Table D” are intended as an illustrative example and should not be construed as a limitation of the present disclosure.

In an embodiment, upon determining the asset level amplified risk score, the computing system 101 may be configured to determine an asset level second score indicating aggregated dynamic criticality of each of the one or more assets 103 based on the asset level amplified risk score of each of the one or more failure modes of each of the one or more assets 103. In an embodiment, the computing system 101 may normalize the asset level amplified risk score of each of the one or more failure modes. Normalization is performed to standardize the amplified risk score of each of the one or more failure modes of each of the one or more assets 103. In an embodiment, the normalization is performed by dividing maximum amplified risk score with each of the amplified risk score. Considering the risk score values from Table D, the normalized values of the risk score are provided below:

TABLE E

| Failure mode | Amplified risk score | Normalized value |
|---|---|---|
| FM1 | 1610 | 0.0 |
| FM2 | 1881 | 0.3 |
| FM3 | 2399 | 1.0 |
| FM4 | 2268 | 0.8 |

The values provided in the above table “Table E” are intended as an illustrative example and should not be construed as a limitation of the present disclosure.

In an embodiment, upon normalizing the amplified risk score, the computing system 101 may determine a weightage for the normalized asset level amplified risk score of each of the one or more failure modes of each of the one or more assets 103 using a first predefined technique. As an example, the first predefined technique may be the polynomial equation (Equation 2) in which the normalized value is used to determine the weightage. Considering the normalized value in Table E, the weightage value determined for each of the one or more failure modes of the compressor are provided below:

TABLE F

| Failure mode | Normalized value | Weightage |
|---|---|---|
| FM1 | 0.0 | 0.00 |
| FM2 | 0.3 | 0.21 |
| FM3 | 1.0 | 0.50 |
| FM4 | 0.8 | 0.48 |

The values provided in the above table “Table F” are intended as an illustrative example and should not be construed as a limitation of the present disclosure.

In an embodiment, upon determining the weightage, the computing system 101 may determine the asset level second score based on the risk score of the one or more failure modes and cumulative weightage score of the each of the one or more failure modes of each of the one or more assets 103. The cumulative weightage score is obtained by aggregating weightage of the each of the one or more failure modes of each of the one or more assets 103. Considering the weightage in Table F, the cumulative weightage score may be determined based on sum of the weightage with a predefined value.

In an embodiment, upon determining the asset level second score, the computing system 101 may be configured to assess dynamic risk of each of the one or more assets 103 based on the asset level first score and the asset level second score. In an embodiment, the computing system 101 may determine at least one critical asset among the one or more assets 103 and at least one critical failure mode of the at least one critical asset based on the assessment of each of the one or more assets 103.

In an embodiment, the computing system 101 may be configured to provide the one or more corrective action recommendations related to the one or more assets based on the assessment. The one or more corrective actions may include, but not limited to, a corrective action, a preventive action, a maintenance action and a decision. As an example, the corrective actions may be an action which may be recommended to correct any fault which has occurred. As an example, the preventive action may be ac action which may be recommended to avoid any fault which may occur. In an embodiment, the computing system 101 may recommend the one or more corrective actions using an Artificial Intelligence (AI) model. In an embodiment, the comparison between the asset level first score and the asset level second score may be provided to an operator associated with the one or more assets 103. In some embodiments, the comparison may be displayed on a display device associated with the computing system 101. In some embodiments, the comparison may be provided to the computing system 101 for further processing. As an example, when the asset level first score is 3686 and the asset level second score is 4104, the percentage difference between the asset level first score and the asset level second score is 89%. This may indicate that the asset is critical and one or more corrective actions may be provided to reduce the percentage difference. In some embodiments, the asset level first score and the asset level second score of the one or more assets 103 may be used to compare and prioritize the critical asset. FIG. 1B shows an exemplary graph of the asset level second score of multiple assets, i.e., centrifugal compressor, turbine and a pump.

As shown in the graph, the centrifugal compressor and turbine have same asset level first score. However, the centrifugal compressor faces frequent failures. These are correctly identified using asset level second score. Also, the turbine has a much higher asset level first score than the pump. Due to frequent failures in the pump, it is more critical in some cases than the turbine. The computing system 101 may determine that the centrifugal compressor is the critical asset among the other assets and the centrifugal compressor may require immediate attention as the criticality has increased. The operator may strategically plan and prioritize the critical asset and the critical failure mode in the critical asset to reduce the asset level second score. In some embodiments, computing system 101 may be configured to strategically plan and prioritize the critical asset and the critical failure mode in the critical asset to reduce the asset level second score. In an embodiment, the critical failure mode is a failure mode having highest increment in the asset level amplified risk score when compared with the risk score received from the at least one input source. For instance, referring to Table, D, failure mode “FM3” may be identified as the critical failure mode.

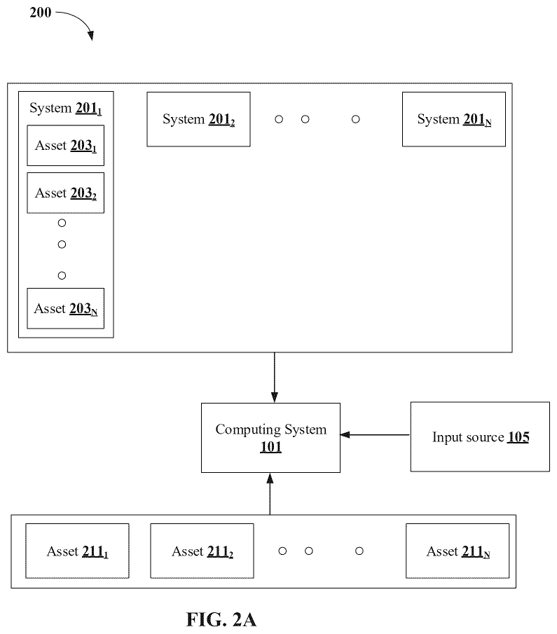

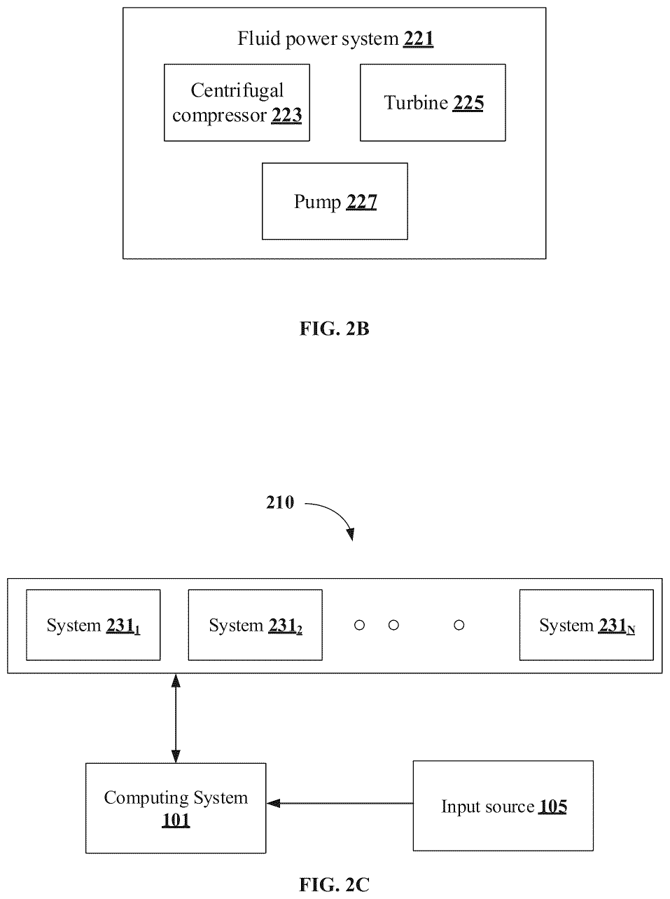

FIG. 2A shows an exemplary architecture for assessing dynamic risk for strategic planning of a system associated with one or more assets, in accordance with some embodiments of the present disclosure.

Exemplary environment 200 comprises a computing system 101, asset 2111 to asset 211N (also referred as one or more assets 211 or assets 211) and system 2011 to system 201N (also referred as one or more systems 201 or systems 201). As an example, the exemplary environment 200 may be an industrial plant environment which may include the one or more systems 201 and the one or more assets 211. In an embodiment, each of the one or more systems 201 may include one or more assets which may be different from the one or more assets 211 independent from the one or more systems 201. For instance, the system 2011 may include one or more assets 2031-203N. Similarly, the one or more systems 201 may include one or more assets (not shown in figure). FIG. 2B shows an exemplary fluid power system 221 which may include three assets, namely, a centrifugal compressor 223, a turbine 225 and a pump 227. In some embodiments, the exemplary environment 200 may include only one or more systems 201 which may include one or more assets, as shown in FIG. 2C. In an embodiment, the computing system 101 may be associated with the one or more systems 201 and the one or more assets 211 using a communication network (not shown in figure).

As an example, the communication network may be a wired communication network, a wireless communication network or a combination of both the wired communication network and the wireless communication network, which enables the connection of the one or more systems 201 and the one or more assets 211 with the computing system 101 for communication. As an example, the computing system 101 may include, without limitation, any device used by a user such as, but not limited to, mobile phones, smartphones, laptops, cloud computing and Personal Computers (PCs). In some embodiments, the computing system 101 may be an existing computing system 101 which was used for performing Failure Mode Effect and Criticality Analysis (FMECA) of the one or more systems 201 using convention technique. In some embodiments, the computing system 101 may be an upgraded version of the existing computing system 101. As an example, the one or more systems 201 may include, without limitation, any electronic system or any mechanical system used in an industry. As an example, the one or more systems 201 may include, at least one of, a wind turbine system, a power station, a manufacturing system and a fluid distribution system. In an embodiment, the one or more systems, one or more assets 211 and the computing system 101 may be associated with an Asset Performance Monitoring (APM) system (not shown in figure) which may be used to track the performance of the one or more systems 201.

In an embodiment, the computing system 101 may be configured to receive at least one of a risk score of each of one or more failure modes of each of one or more assets associated with each of the one or more systems 201, a risk score of each of one or more failure modes of each of one or more systems 201, asset level first score indicating criticality of each of the one or more failure modes of each of the one or more assets, asset level second score indicating dynamic criticality of each of the one or more assets, event data related to the each of the one or more systems 201 and event data related to the each of the one or more assets, from at least one input source 105 associated with the system. In an embodiment, the one or more failure modes of each of the one or more systems 201 may include a specific way in which the system may fail to perform its intended function which may include, without limitation, primary function and secondary function. For example, malfunctioning of the system, performance issues of the system, degradation of the system and the like, which may prevent the system to perform its intended function. As an example, the system may be a hydraulic system.

In an embodiment, the one or more failure modes of each of the one or more assets may include a specific way in which the asset may fail to perform its intended function. For example, malfunctioning of the asset, performance issue of the asset, degradation of the asset and the like, which may prevent the asset to perform its intended function. As an example, if the asset is a compressor, the one or more failure modes may include, without limitation, thrust bearing failure, Non-Drive End (NDE) Dry Gas Seal (DGS) failure, Drive End (DE) bearing failure and DE DGS failure. In an embodiment, the one or more failure modes of each of the one or more systems 201 may be different from each of the one or more failure modes of each of the one or more assets. In other words, the one or more failure modes of each of the one or more systems 201 may be specific to the system and not related to any asset in the system. In an embodiment, each of one or more failure modes may be assigned with the risk score which may be determined based on severity of the failure mode, occurrence of the failure mode and detection of the failure mode. In some embodiments, the risk score may be determined using the Equation 1.

In an embodiment, the severity of the failure mode, the occurrence of the failure mode and the detection of the failure mode may be performed periodically by an operator based on the knowledge of the operator and the criticality of the failure mode.

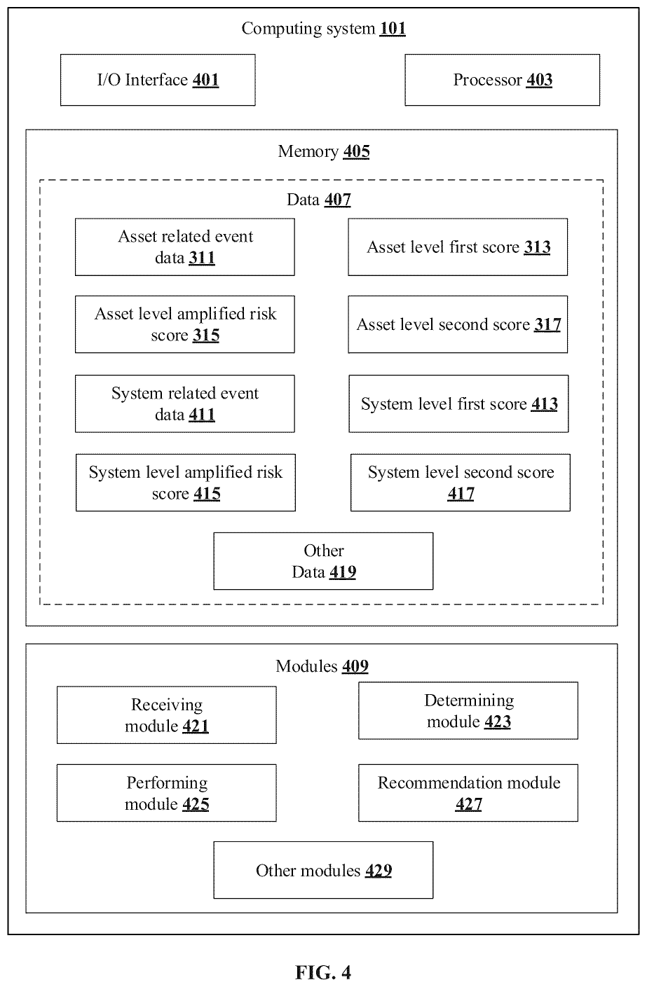

In an embodiment, the event data related to each of the one or more systems 201 may be generated based on at least one of analytics information related to the one or more systems 201 received from analytics data sources, alerts and warnings related to the one or more systems 201 received from control systems, and notifications related to the one or more systems 201 received from Enterprise Resource Planning (ERP) systems. In an embodiment, the event data related to each of the one or more systems 201 may indicate at least one of a plurality of characteristics associated with each of one or more events related to corresponding one or more systems 201. In an embodiment, the event data may be received from the APM system associated with the computing system 101 and the one or more systems 201. The event data related to each of the one or more systems 201 is discussed in detail in FIG. 4 of the present disclosure. The at least one input source 105 associated with each of the one or more systems 201 may include, without limitation, an Asset Performance Monitoring (APM) system for receiving the event data and computing system 101 to receive the risk score of each of the failure modes of each of the one or more systems 201. The event data related to each of the one or more assets is discussed in detail in FIG. 1A and FIG. 3.

In an embodiment, upon receiving the risk score and the event data of each of the one or more failure modes of each of the one or more assets and of each of the one or more failure modes of each of the one or more systems 201, respectively, the computing system 101 may be configured to determine a system level first score indicating aggregated criticality of each of the one or more systems 201 based on at least one of the risk score of each of the one or more failure modes of each of the one or more systems 201, and one of the risk score of each of the one or more failure modes of each of the one or more assets and the asset level first score.

In some embodiments, the computing system 101 may determine the system level second score based on the risk score of each of the one or more failure modes of each of the one or more systems 201 and one of the risks scores of each of the one or more failure modes of each of the one or more assets. In an embodiment, the computing system 101 may normalize the risk score of each of the one or more failure modes of each of the one or more systems 201 and the risk score of each of one or more failure modes of each of the one or more assets. Normalization is performed to standardize the risk score of each of the one or more failure modes of each of the one or more assets and the risk score of each of the one or more failure modes of each of the one or more systems 201. In an embodiment, the normalization is performed by dividing maximum risk score with each of the risk scores. As an example, the risk score and the normalized values of the risk score is provided below:

TABLE G

| Failure mode of | | |
|---|---|---|
| Asset/System | Risk score | Normalized value |
| Asset 1 | 1073 | 0.0 |
| FM1 | 1254 | 0.2 |
| Asset 2 | 1919 | 1.0 |
| Asset 3 | 2300 | 1.5 |

The values provided in the above table “Table G” are intended as an illustrative example and should not be construed as a limitation of the present disclosure.

In an embodiment, upon normalizing the risk score, the computing system 101 may determine a weightage for the normalized risk score of each of the one or more failure modes of each of the one or more systems 201 using a first predefined technique. As an example, the first predefined technique may be a polynomial equation in which the normalized value is used to determine the weightage. In some embodiments, “equation 2” may be the polynomial equation.

Considering the normalized value in Table G, the weightage value determined for each of the one or more failure modes are provided below:

TABLE H

| Failure mode of | | |
|---|---|---|
| Asset/System | Normalized value | Weightage |
| Asset 1 | 0.0 | 0.00 |
| FM1 | 0.2 | 0.12 |
| Asset 2 | 1.0 | 0.50 |
| Asset 3 | 1.5 | 0.25 |

The values provided in the above table “Table H” are intended as an illustrative example and should not be construed as a limitation of the present disclosure.

In an embodiment, upon determining the weightage, the computing system 101 may determine the system level first score based on the risk score of the one or more failure modes and cumulative weightage score of the each of the one or more failure modes of each of the one or more systems 201. The cumulative weightage score may be obtained by aggregating weightage of each of the one or more failure modes of each of the one or more systems 201.

In some embodiments, the computing system 101 may determine the system level first score based on the risk score of each of the one or more failure modes of each of the one or more systems 201 and the asset level first score. In some other embodiments, the computing system 101 may directly receive the asset level first score of each of the one or more assets (FIG. 1A describes the steps for determining the asset level first score) which may be directly used by the computing system 101 to determine the system level second score. The computing system 101 may perform similar steps to determine the system level first score as described above.

In an embodiment, upon determining the system level first score, the computing system 101 may be configured to determine a system level amplified risk score of each of the one or more failure modes based on the risk score of each of the one or more failure modes of each of the one or more systems 201 and the event data related to each of the one or more systems 201. In an embodiment, the computing system 101 may determine at least one weightage value for each of the one or more systems 201 based on the event data and a plurality of characteristics associated with each of one or more events related to the corresponding one or more systems 201. The plurality of characteristics may include, without limitation, type of event, type of notification, time at which the notification was generated, open events which are not resolved, and number of notifications generated for each event. The type of event may include, without limitation, rule based, condition indicator, and unsupervised event. The type of notification may include, without limitation, an alert and a warning. Further, the computing system 101 may determine an amplification factor for each of the one or more failure modes of each of the one or more systems 201 based on the at least one weightage value using a second predefined technique. The method of determining the at least one weightage value and the amplification factor is discussed in FIG. 4 of the present disclosure. The second predefined technique may be an equation in which the at least one weightage value is used to determine the amplification factor. In some embodiments, “equation 3” may be used to determine the amplification factor.

Thereafter, the computing system 101 may determine the system level amplified risk score of each of the one or more failure modes of each system in the one or more systems 201 based on the risk score of each of the one or more failure modes of each of the one or more systems 201 and the corresponding amplification factor. The amplification factor may be multiplied with the risk score of each of the one or more failure modes to obtain the system level amplified risk score of each of the one or more failure modes. Considering the risk score values in the Table G, the amplification factor, the amplified risk score for the corresponding one or more failure modes are shown in Table I below:

TABLE I

| Failure mode of | | Amplification | |
|---|---|---|---|
| Asset/System | Risk score | factor | Amplified risk score |
| Asset 1 | 1073 | 1.50 | 1610 |
| FM1 | 1254 | 1.50 | 1881 |
| Asset 2 | 1919 | 1.25 | 2399 |
| Asset 3 | 2300 | 1.00 | 2300 |

The values provided in the above table “Table I” are intended as an illustrative example and should not be construed as a limitation of the present disclosure.

In an embodiment, upon determining the system level amplified risk score, the computing system 101 may be configured to determine a system level second score indicating aggregated dynamic criticality of each of the one or more systems 201 based on at least one of, the system level amplified risk score of each of the one or more failure modes of each of the one or more systems 201, and one of an asset level amplified risk score of each of the one or more failure modes of each of the one or more assets or the asset level second score.

In an embodiment, the computing system 101 may determine the system level second score based on the system level amplified risk score of each of the one or more failure modes of each of the one or more systems 201 and the one of an asset level amplified risk score of each of the one or more failure modes of each of the one or more assets. The asset level amplified risk score may be determined based on the risk score of each of the one or more failure modes of each of the one or more assets and the event data related to each of the one or more assets (as explained in FIG. 1A and FIG. 3). In an embodiment, the computing system 101 may normalize the system level amplified risk score of each of the one or more failure modes. Normalization is performed to standardize the amplified risk score of each of the one or more failure modes of each of the one or more systems 201. In an embodiment, the normalization is performed by dividing maximum amplified risk score with each of the amplified risk score. Considering the risk score values from Table I, the normalized values of the risk score is provided below:

TABLE J

| Failure mode | Amplified risk score | Normalized value |
|---|---|---|
| Asset 1 | 1610 | 0.0 |
| FM1 | 1881 | 0.3 |
| Asset 2 | 2399 | 1.0 |
| Asset 3 | 2268 | 0.8 |

The values provided in the above table “Table J” are intended as an illustrative example and should not be construed as a limitation of the present disclosure.

In an embodiment, upon normalizing the amplified risk score, the computing system 101 may determine a weightage for the normalized asset level amplified risk score of each of the one or more failure modes of each of the one or more systems 201 using a first predefined technique. As an example, the first predefined technique may be the polynomial equation in which the normalized value is used to determine the weightage. In some embodiments, “equation 2” may be the polynomial equation.

Considering the normalized value in Table J, the weightage value determined for each of the one or more failure modes of are provided below:

TABLE K

| Failure mode | Normalized value | Weightage |
|---|---|---|
| Asset 1 | 0.0 | 0.00 |
| FM1 | 0.3 | 0.21 |
| Asset 2 | 1.0 | 0.50 |
| Asset 3 | 0.8 | 0.48 |

The values provided in the above table “Table K” are intended as an illustrative example and should not be construed as a limitation of the present disclosure.

In an embodiment, upon determining the weightage, the computing system 101 may determine the system level second score based on the risk score of the one or more failure modes and cumulative weightage score of the each of the one or more failure modes of each of the one or more systems 201. The cumulative weightage score is obtained by aggregating weightage of the each of the one or more failure modes of each of the one or more systems 201.

In some embodiments, the computing system 101 may determine the system level second score based on the system level amplified risk score of each of the one or more failure modes of each of the one or more systems 201 and the asset level second score. In an embodiment, the computing system 101 may directly receive the asset level second score of each of the one or more assets (FIG. 1A describes the steps for determining the asset level second score) which may be directly used by the computing system 101 to determine the system level second score. The computing system 101 may perform similar steps to determine the system level second score as described above.

In an embodiment, upon determining the asset level second score, the computing system 101 may be configured to assess dynamic risk of each of the one or more systems 201 based on the system level first score and the system level second score. In an embodiment, the computing system 101 may determine at least one critical system among the one or more systems 201, based on the assessment of each of the one or more systems 201. In some embodiments, computing system 101 may determine at least one critical asset among the one or more assets, based on the assessment of each of the one or more systems 201. In some embodiments, computing system 101 may determine at least one critical failure mode of the at least one critical system and the at least one critical asset, based on the assessment of each of the one or more systems 201 and each of the one or more assets 103.

In an embodiment, the computing system 101 may be configured to provide the one or more corrective action recommendations related to the one or more systems based on the assessment. The one or more corrective actions may comprise at least one of, a corrective action, a preventive action, maintenance action, and a decision. As an example, the corrective actions may be an action which may be recommended to correct any fault which has occurred. As an example, the preventive action may be ac action which may be recommended to avoid any fault which may occur. In an embodiment, the computing system 101 may recommend the one or more corrective actions using an Artificial Intelligence (AI) model. The operator may strategically plan and prioritize at least one of the critical system, critical failure mode in the critical system, critical asset and the critical failure mode in the critical asset to reduce the system level second score and asset level second score. In some embodiments, computing system 101 may be configured to strategically plan and prioritize the at least one critical system among the one or more systems, at least one critical asset among the one or more assets and at least one critical failure mode of the at least one critical system and the at least one critical asset to reduce the system level second score. As an example, referring to Table I, the critical asset may be Asset 2.

FIG. 3 shows a detailed block diagram of a computing system 101 for assessing dynamic risk for strategic planning of one or more assets, in accordance with some embodiments of the present disclosure.

In some implementations, the computing system 101 may include an I/O interface 301, a processor 303 and a memory 305. In an embodiment, the memory 305 may be communicatively coupled to the processor 303. The processor 303 may be configured to perform one or more functions of the computing system 101 for assessing dynamic risk for strategic planning of one or more assets, using the data 307 and the one or more modules 309 of the computing system 101. In an embodiment, the memory 305 may store data 307.

In an embodiment, the data 307 stored in the memory 305 may include, without limitation, event data related to assets 311, asset level first score 313, asset level amplified risk score 315, asset level second score 317 and other data 319. In some implementations, the data 307 may be stored within the memory 305 in the form of various data structures. Additionally, the data 307 may be organized using data models, such as relational or hierarchical data models. The other data 319 may include various temporary data and files generated by the one or more modules 309.

In an embodiment, the event data related to assets 311 may indicate at least one of a plurality of characteristics associated with each of one or more events related to corresponding one or more assets. In an embodiment, the event data may be generated based on at least one of analytics information related to the one or more assets received from analytics data sources, alerts and warnings related to the one or more assets received from control systems, and notifications related to the one or more assets received from Enterprise Resource Planning (ERP) systems. In an embodiment, the analytics data sources may include one or more types of analytics models. The following are examples of analytics models which may include, without limitation: Fault detection—This analytics model detects fault based on past data on near real time basis; Anomaly/Changepoint detection—This analytics model detects anomalies in operation on near real time; Prediction/forecast—These analytics model predicts behavior of parameters or demand of some entities in future. These are forecast type analytic; Condition indicator—These analytics model extracts some features from high frequency data which can be consumed by other analytics on near real time basis; Remaining Useful Life (RUL)—RUL analytics predict time remaining till failure. These are forecast type analytics; Vibration monitoring—This analytics model detects faults based on signal processing on near real time basis; Reliability—This analytics model detects provides several outputs based on reliability analysis on near real time basis.

The output of above analytics may be alarms, warnings or any numeric output such as no of days remaining till failure, probability of failure and the same. In an embodiment, sensor data may be gathered by the control system. Also, the alarms and the warnings may be configured based on the following conditions: Threshold breaching-If parameter crosses predefined thresholds; Derived parameters-Derived parameters are calculated based on combinations of one or more parameters and can be monitored.

In an embodiment, the notification may be received from the ERP systems, i.e., during maintenance of the one or more assets, work orders may be generated and can be accessed through ERP systems such as Systems, Applications and Products (SAP). These are used based on the following: Number of work orders for given asset or system; Open work orders for given asset or system; Average lead time for each work order; ABC indicators.

In an embodiment, the plurality of characteristics may include, without limitation, type of event, type of notification, time at which the notification was generated, open events which are not resolved, and number of notifications generated for each event. The type of notification may include, without limitation, an alert and a warning. The type of event may include, without limitation, rule based, condition indicator, unsupervised event, changepoint, Remaining Useful Life (RUL) and time series. In an embodiment, each type of event may be indicated using a warning and/or an alert. Further, weights may be assigned to the warning and the alert of each type of event which may be used to determine the asset level amplified risk score. Table L shows exemplary weights for the warning and the alert of each type of event. In an embodiment, the event data related to assets 311 may be used to determine the asset level amplified risk score of each of the one or more failure modes, which is discussed further in the present disclosure.

TABLE L

| Event Type | Alert | Warning |
|---|---|---|
| Event Type1 | 1 | 0.75 |
| Event Type2 | 0.8 | 0.5 |
| Event Type3 | 0.75 | 0.6 |
| Event Type4 | 0.95 | 0.71 |
| Event Type5 | 1 | 0.82 |
| Event Type6 | 0.9 | 0.4 |

The values provided in the above table “Table L” are intended as an illustrative example and should not be construed as a limitation of the present disclosure.

In an embodiment, the asset level first score 313 may indicate aggregated criticality of each of the one or more assets which may be determined based on the risk score of each of the one or more failure modes of each of the one or more assets. In an embodiment, the asset level first score 313 may be used to determine the asset level amplified risk score 315. Further the asset level first score 313 may be used to perform the assessment of each of the one or more assets.

In an embodiment, the asset level amplified risk score 315 may indicate an amplified risk score of each of the one or more failure modes of each of the one or more assets which may be determined based on the risk score of each of the one or more failure modes of each of the one or more assets and the event data related to each of the one or more assets. In an embodiment, the asset level amplified risk score 315 may be a dynamic value which is determined based on real-time events and near real-time events.

In an embodiment, the asset level second score 317 may indicate aggregated dynamic criticality of each of the one or more assets based on the asset level amplified risk score of each of the one or more failure modes of each of the one or more assets. In an embodiment, the asset level second score 317 may be used to assess dynamic risk of each of the one or more assets.

In an embodiment, the other data 319 may store data related to the one or more assets and corresponding one or more failure modes. As an example, the data related to the one or more assets may be, without limitation, asset Identification (ID), asset location, asset name and the like.

In an embodiment, the data 307 may be processed by one or more modules 309 of the computing system 101. In some implementations, the one or more modules 309 may be communicatively coupled to the processor 303 for performing one or more functions of the computing system 101. In an implementation, the one or more modules 309 may include, without limiting to, a receiving module 321, a determining module 323, an assessment module 325, recommendation module 327 and other modules 329.

As used herein, the term module may refer to an Application Specific Integrated Circuit (ASIC), an electronic circuit, a hardware processor 303 (shared, dedicated, or group) and memory that execute one or more software or firmware programs, a combinational logic circuit, and/or other suitable components that provide the described functionality. In an implementation, each of the one or more modules 309 may be configured as stand-alone hardware computing units. In an embodiment, the other modules 329 may be used to perform various miscellaneous functionalities on the computing system 101. It will be appreciated that such one or more modules 309 may be represented as a single module or a combination of different modules.

In an embodiment, the receiving module 321 may be configured for receiving a risk score of each of one or more failure modes of each of one or more assets and event data related to each of the one or more assets from at least one input source 105 associated with each of the one or more assets. The at least one input source 105 associated with each of the one or more assets may include, without limitation, an Asset Performance Monitoring (APM) system for receiving the event data and a computing system 101 to receive the risk score of each of the failure modes of each of the one or more assets. In an embodiment, the risk score of each of the failure modes of each of the one or more assets may be received from an operator associated with the one or more assets. The at least one input source 105 associated with each of the one or more assets may include, without limitation, the APM system for receiving the event data and computing system 101 to receive the risk score of each of the failure modes of each of the one or more assets.

In an embodiment, the determining module 323 may be configured for determining an asset level first score 313 indicating aggregated criticality of each of the one or more assets based on the risk score of each of the one or more failure modes of each of the one or more assets. In an embodiment, the determining module 323 may normalize the risk score of each of the one or more failure modes of each of the one or more assets. Further, the determining module 323 may determine a weightage for the normalized risk score of each of the one or more failure modes of each of the one or more assets using a first predefined technique. Upon determining the weightage, the determining module 323 may determine the asset level first score 313 based on the risk score of the one or more failure modes and cumulative weightage score of the each of the one or more failure modes of each of the one or more assets. The cumulative weightage score is obtained by aggregating weightage of each of the one or more failure modes of each of the one or more assets.

In an embodiment, the determining module 323 may be configured for determining an asset level amplified risk score 315 of each of the one or more failure modes based on the risk score of each of the one or more failure modes of each of the one or more assets and the event data related to each of the one or more assets. In an embodiment, the determining module 323 may determine at least one weightage value for each of the one or more assets based on the event data and a plurality of characteristics associated with each of one or more events related to the corresponding one or more assets. The plurality of characteristics may include, without limitation, type of event, type of notification, time at which the notification was generated, open events which are not resolved, and number of notifications generated for each event. The type of event may include, without limitation, rule based, condition indicator, unsupervised event, changepoint, Remaining Useful Life (RUL) and time series. The type of notification may include, without limitation, an alert and a warning. As shown in Table L, exemplary weights for the warning and the alert of each type of event may be assigned.

In an embodiment, the weights may be used to determine the amplification factor along with the plurality of characteristics associated with each of one or more events. In an embodiment, the determining module 323 may determine first weight (w1) based on the type of the event. As an example, as per Table L, the rule-based event is more severe than the KDI. Further, the determining module 323 may determine second weight (w2) based on time of notification. As an example, as per Table L, the alert is more severe than the warning. In an embodiment, persistence of the event may be determined based on number of notifications received for the event. In other words, for event persistence, open events are considered as multiple events. Consider an exemplary scenario in which the event started at 10:00 AM and ended at 11:00 AM. The event is considered as an open event until the event is closed/resolved. The APM system may check the event status periodically until the event is closed. If the frequency of checking event status is 15 minutes, then the event may be considered as 5 times between 10:00 AM and 11:00 AM. In an embodiment, the determining module 323 may determine amplification factor for each event in a predefined duration. As an example, the predefined duration may be 24 Hours. In an embodiment, the determining module 323 may determine the amplification factor for each of the one or more failure modes of each of the one or more assets based on the at least one weightage value using a second predefined technique. The weights w1 and w2 may be used in Equation 3 to determine the amplification factor. In an embodiment, the determining module 323 may determine the asset level amplified risk score 315 of each of the one or more failure modes of each asset in the one or more assets based on the risk score of each of the one or more failure modes of each of the one or more assets and the corresponding amplification factor. As an example, the amplification factor, the amplified risk score for the corresponding one or more failure modes are shown in Table D.

In an embodiment, the determining module 323 may be configured for determining an asset level first score 317 indicating aggregated dynamic criticality of each of the one or more assets based on the asset level amplified risk score 315 of each of the one or more failure modes of each of the one or more assets. In an embodiment, the determining module 323 may normalize the asset level amplified risk score 315 of each of the one or more failure modes. Further, the determining module 323 may determine a weightage for the normalized asset level amplified risk score of each of the one or more failure modes using a first predefined technique. Upon determining the weightage, the determining module 323 may determine the asset level first score 317 based on the risk score of the one or more failure modes and a cumulative weightage score of the each of the one or more failure modes. The cumulative weightage score is obtained by aggregating weightage of the each of the one or more failure modes.

In an embodiment, the assessment module 325 may be configured for assessing dynamic risk of each of the one or more assets based on the asset level first score 313 and the asset level first score 317. In an embodiment, the determining module 323 may determine at least one critical asset among the one or more assets and at least one critical failure mode of the at least one critical asset based on the assessment of each of the one or more assets.

In an embodiment, the recommendation module 327 may be configured for providing one or more corrective action recommendations related to the one or more assets based on the assessment. The one or more corrective actions may comprise at least one of, a corrective action, a preventive action, a maintenance action, and a decision. In an embodiment, the recommendation module 327 may recommend the one or more corrective actions using an Artificial Intelligence (AI) model.

FIG. 4 shows a detailed block diagram of a computing system 101 for assessing dynamic risk for strategic planning of a system associated with one or more assets, in accordance with some embodiments of the present disclosure.

In some implementations, the computing system 101 may include an I/O interface 401, a processor 403 and a memory 405. In an embodiment, the memory 405 may be communicatively coupled to the processor 403. The processor 403 may be configured to perform one or more functions of the computing system 101 for assessing dynamic risk for strategic planning of one or more assets, using the data 407 and the one or more modules 409 of the computing system 101. In an embodiment, the memory 405 may store data 407.

In an embodiment, the data 407 stored in the memory 405 may include, without limitation, event data related to assets 311, asset level first score 313, asset level amplified risk score 315, asset level first score 317 317, event data related to systems 411, system level first score 413, system level amplified risk score 415, system level second score 417 and other data 419. In some implementations, the data 407 may be stored within the memory 405 in the form of various data structures. Additionally, the data 407 may be organized using data models, such as relational or hierarchical data models. The other data 419 may include various temporary data and files generated by the one or more modules 409.

In an embodiment, the event data related to assets 311, the asset level first score 313, the asset level amplified risk score 315 and the asset level first score 317 317 are discussed in FIG. 3, and the same is referred here in its entirety. The data associated with the one or more assets are received and used to evaluate dynamic risk of a system associated with one or more assets for strategic planning. In an embodiment, the system may comprise one or more assets. In some embodiments, the one or more assets may be independent assets which may not be related to the system. However, the one or more assets may be related to same industrial plant of the system.

In an embodiment, the event data related to systems 411 may indicate at least one of a plurality of characteristics associated with each of one or more events related to corresponding one or more systems. In an embodiment, the event data related to systems 411 may be generated based on at least one of analytics information related to the one or more systems received from analytics data sources, alerts and warnings related to the one or more systems received from control systems, and notifications related to the one or more assets received from Enterprise Resource Planning (ERP) systems. In an embodiment, the analytics data sources may include one or more types of analytics models. The following are examples of analytics models which may include, without limitation: Fault detection—This analytics model detects fault based on past data on near real time basis; Anomaly/Changepoint detection—These analytics model detects anomalies in operation on near real time; Prediction/forecast—These analytics model predicts behavior of parameters or demand of some entities in future. These are forecast type analytic; Condition indicator—This analytics model extracts some features from high frequency data which can be consumed by other analytics on near real time basis; Remaining Useful Life (RUL)—RUL analytics predict time remaining till failure (these are forecast type analytics); Vibration monitoring—This analytics model detects faults based on signal processing on near real time basis; Reliability—This analytics model detects provides several outputs based on reliability analysis on near real time basis.

The output of above analytics may be alarms, warnings or any numeric output such as no. of days remaining till failure, probability of failure and the same. In an embodiment, sensor data may be gathered by the control system. Also, the alarms and the warnings may be configured based on the following conditions: Threshold breaching—If parameter crosses predefined thresholds; Derived parameters—Derived parameters are calculated based on combinations of one or more parameters and can be monitored.

In an embodiment, the notification may be received from the ERP systems, i.e., during maintenance of the one or more assets, work orders may be generated and can be accessed through ERP systems such as Systems, Applications and Products (SAP). These are used based on the following: Number of work orders for given asset or system; Open work orders for given asset or system; Average lead time for each work order; ABC indicators.

In an embodiment, the plurality of characteristics may include, without limitation, type of event, type of notification, time at which the notification was generated, open events which are not resolved, and number of notifications generated for each event. The type of event may include, without limitation, rule based, condition indicator, unsupervised event, changepoint, Remaining Useful Life (RUL) and time series. In an embodiment, each of the type of events may be indicated using a warning and/or an alert. Further, weights may be assigned to the warning and the alert of each of the type of event which may be used to determine the system level amplified risk score. Table M shows an exemplary weight for the warning and the alert of each of the event type. The type of notification may include, without limitation, an alert and a warning. In an embodiment, the event data related to systems 411 may be used to determine the system level amplified risk score of each of the one or more failure modes, which is discussed further in the present disclosure.

TABLE M

| Event Type | Alert | Warning |
|---|---|---|
| Event Type1 | 1 | 0.75 |
| Event Type2 | 0.8 | 0.5 |
| Event Type3 | 0.75 | 0.6 |
| Event Type4 | 0.95 | 0.71 |
| Event Type5 | 1 | 0.82 |
| Event Type6 | 0.9 | 0.4 |

The values provided in the above table “Table M” are intended as an illustrative example and should not be construed as a limitation of the present disclosure.

In an embodiment, the system level first score 413 may indicate indicating aggregated criticality of each of the one or more systems which may be determined based on at least one of the risk score of each of the one or more failure modes of each of the one or more systems, and one of the risk score of each of the one or more failure modes of each of the one or more assets and the asset level first score 313. In an embodiment, the system level first score 413 may be used to determine the asset level amplified risk score 315. Further the asset level first score 313 may be used to assess dynamic risk of each of the one or more assets.

In an embodiment, the system level amplified risk score 415 may indicate an amplified risk score of each of the one or more failure modes of each of the one or more systems which may be determined based on the risk score of each of the one or more failure modes of each of the one or more systems and the event data related to each of the one or more systems. In an embodiment, the system level amplified risk score 415 may be a dynamic value which is determined based on real-time events and near real-time events.

In an embodiment, the system level second score 417 may indicate aggregated dynamic criticality of each of the one or more systems based on at least one of, the system level amplified risk score 415 of each of the one or more failure modes of each of the one or more systems, and one of an asset level amplified risk score 315 of each of the one or more failure modes of each of the one or more assets or the asset level first score 317. The asset level amplified risk score 315 may be determined based on the risk score of each of the one or more failure modes of each of the one or more assets and the event data related to each of the one or more assets. In an embodiment, the system level second score 417 may be used to assess dynamic risk of each of the one or more assets.

In an embodiment, the other data 419 may store data related to the one or more systems and corresponding one or more failure modes. As an example, the data related to the one or more systems may be, without limitation, system Identification (ID), system location, system name, number of assets associated with the system and the like.

In an embodiment, the data 407 may be processed by one or more modules 409 of the computing system 101. In some implementations, the one or more modules 409 may be communicatively coupled to the processor 403 for performing one or more functions of the computing system 101. In an implementation, the one or more modules 409 may include, without limiting to, a receiving module 421, a determining module 423, an assessment module 425, recommendation module 427 and other modules 429.

As used herein, the term module may refer to an Application Specific Integrated Circuit (ASIC), an electronic circuit, a hardware processor 403 (shared, dedicated, or group) and memory that execute one or more software or firmware programs, a combinational logic circuit, and/or other suitable components that provide the described functionality. In an implementation, each of the one or more modules 409 may be configured as stand-alone hardware computing units. In an embodiment, the other modules 429 may be used to perform various miscellaneous functionalities on the computing system 101. It will be appreciated that such one or more modules 409 may be represented as a single module or a combination of different modules.

In an embodiment, the receiving module 421 may be configured for receiving at least one of a risk score of each of one or more failure modes of each of one or more assets associated with each of the one or more systems, a risk score of each of one or more failure modes of each of one or more systems, asset level first score 313 indicating criticality of each of the one or more failure modes of each of the one or more assets, asset level first score 317 indicating dynamic criticality of each of the one or more assets, event data related to the each of the one or more systems and event data related to the each of the one or more assets, from at least one input source 105 associated with the system.

In an embodiment, the determining module 423 may be configured for determining a system level first score 413 indicating aggregated criticality of each of the one or more systems based on at least one of the risk score of each of the one or more failure modes of each of the one or more systems, and one of the risk score of each of the one or more failure modes of each of the one or more assets and the asset level first score 313. In an embodiment, the determining module 423 may normalize the risk score of each of the one or more failure modes of each of the one or more systems and the risk score of each of one or more failure modes of each of the one or more assets. Further, the determining module 423 may determine a weightage for the normalized risk score of each of the one or more failure modes of each of the one or more systems and each of one or more failure modes of each of the one or more assets using a first predefined technique.

Upon determining the weightage, the determining module 423 may the system level first score 413 based on the risk score of the one or more failure modes and cumulative weightage score of the each of the one or more failure modes of each of the one or more systems and each of one or more failure modes of each of the one or more assets. The cumulative weightage score is obtained by aggregating weightage of the each of the one or more failure modes of each of the one or more systems and each of one or more failure modes of each of the one or more assets.

In an embodiment, the determining module 423 may be configured for determining the system level amplified risk score 415 of each of the one or more failure modes based on the risk score of each of the one or more failure modes of each of the one or more systems and the event data related to each of the one or more systems. In an embodiment, the determining module 423 may determine at least one weightage value for each of the system based on the event data and a plurality of characteristics associated with each of one or more events related to the corresponding system. The plurality of characteristics may include, without limitation, type of event, type of notification, time at which the notification was generated, open events which are not resolved, and number of notifications generated for each event. The type of event may include, without limitation, rule based, condition indicator, unsupervised event, changepoint, Remaining Useful Life (RUL) and time series. The type of notification may include, without limitation, an alert and a warning. As shown in Table M, exemplary weights for the warning and the alert of each of the type of events may be assigned.

In an embodiment, the weights may be used to determine the amplification factor along with the plurality of characteristics associated with each of one or more events. In an embodiment, the determining module 423 may determine first weight (w1) based on the type of the event. As an example, as per Table M, the event type 1 is more severe than the event type 2, event type 3, event type 4 and event type 6. Further, the determining module 423 may determine second weight (w2) based on time of notification. In an embodiment, persistence of the event may be determined based on number of notifications received for the event. In other words, for event persistence, open events are considered as multiple events. Consider an exemplary scenario in which the event started at 10:00 AM and ended at 11:00 AM. The event is considered as an open event until the event is closed/resolved. The APM system may check the event status periodically until the event is closed. If the frequency of checking event status is 15 minutes, then the event may be considered as 5 times between 10:00 AM and 11:00 AM.

In an embodiment, the determining module 423 may determine amplification factor for each event in a predefined duration. As an example, the predefined duration may be 24 Hours. In an embodiment, the determining module 423 may determine the amplification factor for each of the one or more failure modes of each of the one or more systems based on the at least one weightage value using a second predefined technique. The weights w1 and w2 may be used in Equation 3 to determine the amplification factor. In an embodiment, the determining module 423 may determine the system level amplified risk score 415 of each of the one or more failure modes of each of the one or more systems based on the risk score of each of the one or more failure modes of each of the one or more systems and the corresponding amplification factor. As an example, the amplification factor, the amplified risk score for the corresponding one or more failure modes are shown in Table D.

In an embodiment, the determining module 423 may be configured for determining a system level second score 417 indicating aggregated dynamic criticality of each of the one or more systems based on at least one of, the system level amplified risk score 415 of each of the one or more failure modes of each of the one or more systems, and one of an asset level amplified risk score 315 of each of the one or more failure modes of each of the one or more assets or the asset level first score 317. The asset level amplified risk score 315 may be determined based on the risk score of each of the one or more failure modes of each of the one or more assets and the event data related to each of the one or more assets.

In an embodiment, the determining module 423 may normalize the system level amplified risk score 415 of each of the one or more failure modes of each of the one or more systems and the asset level amplified risk score 315 of each of the one or more failure modes of each of the one or more assets. Further, the determining module 423 may determine a weightage for the normalized system level amplified risk score of each of the one or more failure modes of each of the one or more systems and each of the one or more failure modes of each of the one or more assets using a first predefined technique. Upon determining the weightage, the determining module 423 may determine the system level second score 417 based on the risk score of the one or more failure modes and a cumulative weightage score of the each of the one or more failure modes of the one or more systems and each of the one or more failure modes of each of the one or more assets. The cumulative weightage score may be obtained by aggregating weightage of the each of the one or more failure modes of each of the one or more systems and each of the one or more failure modes of each of the one or more assets.

In an embodiment, the assessment module 425 may be configured for assessing dynamic risk of each of the one or more systems based on the system level first score 413 and the system level second score 417. In an embodiment, the determining module 423 may determine at least one critical system among the one or more systems, at least one critical asset among the one or more assets and at least one critical failure mode of the at least one critical system and the at least one critical asset, based on the assessment of each of the one or more systems.

In an embodiment, the recommendation module 427 may be configured for providing one or more corrective action recommendations related to the one or more systems based on the assessment. The one or more corrective actions may comprise at least one of, a corrective action, a preventive action, a maintenance action and a decision. In an embodiment, the assessment module 425 may recommend the one or more corrective actions using an Artificial Intelligence (AI) model.

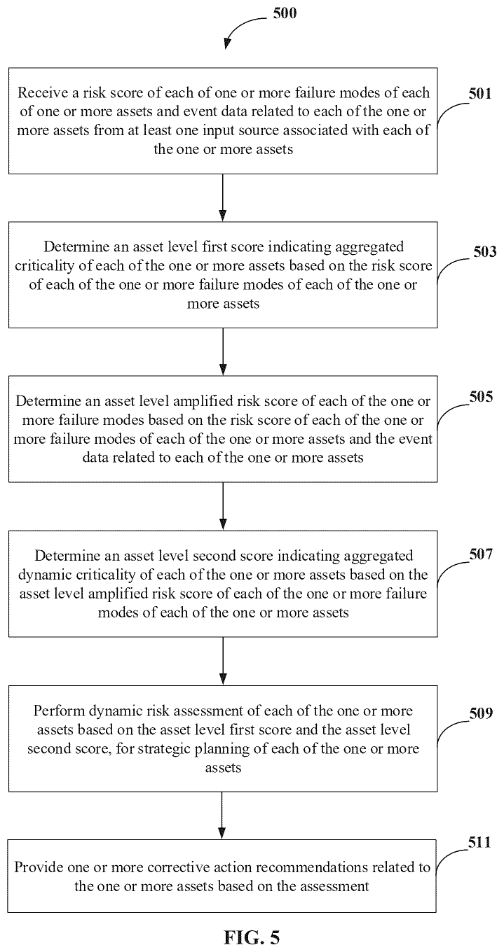

FIG. 5 shows a flowchart illustrating a method of assessing dynamic risk for strategic planning of one or more assets, in accordance with some embodiments of the present disclosure.

As illustrated in FIG. 5, the method 500 may include one or more blocks illustrating a method of assessing dynamic risk for strategic planning of one or more assets using a computing system 101 illustrated in FIG. 3. The method 500 may be described in the general context of computer executable instructions. Generally, computer executable instructions can include routines, programs, objects, components, data structures, procedures, modules, and functions, which perform specific functions or implement specific abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 501, the method 500 includes receiving, by a processor 303 associated with the computing system 101, a risk score of each of one or more failure modes of each of one or more assets and event data related to each of the one or more assets from at least one input source 105 associated with each of the one or more assets. The event data is generated based on at least one of analytics information related to the one or more assets received from analytics data sources, alerts and warnings related to the one or more assets received from control systems, and notifications related to the one or more assets received from Enterprise Resource Planning (ERP) systems. The event data indicates at least one of a plurality of characteristics associated with each of one or more events related to corresponding one or more assets.

At block 503, the method 500 includes determining, by the processor 303, an asset level first score 313 indicating aggregated criticality of each of the one or more assets based on the risk score of each of the one or more failure modes of each of the one or more assets. In an embodiment, the processor 303 may normalize the risk score of each of the one or more failure modes of each of the one or more assets. Further, the processor 303 may determine a weightage for the normalized risk score of each of the one or more failure modes of each of the one or more assets using a first predefined technique. Thereafter, the processor 303 may determine the asset level first score 313 based on the risk score of the one or more failure modes and cumulative weightage score of the each of the one or more failure modes of each of the one or more assets. The cumulative weightage score is obtained by aggregating weightage of each of the one or more failure modes of each of the one or more assets.

At block 505, the method 500 includes determining, by the processor 303, an asset level amplified risk score 315 of each of the one or more failure modes based on the risk score of each of the one or more failure modes of each of the one or more assets and the event data related to each of the one or more assets. In an embodiment, the processor 303 may determine at least one weightage value for each of the one or more assets based on the event data and a plurality of characteristics associated with each of one or more events related to the corresponding one or more assets. Further, the processor 303 may determine an amplification factor for each of the one or more failure modes of each of the one or more assets based on the at least one weightage value using a second predefined technique. Thereafter, the processor 303 may determine the asset level amplified risk score 315 of each of the one or more failure modes of each asset in the one or more assets based on the risk score of each of the one or more failure modes of each of the one or more assets and the corresponding amplification factor.

At block 507, the method 500 includes determining, by the processor 303, an asset level first score 317 indicating aggregated dynamic criticality of each of the one or more assets based on the asset level amplified risk score 315 of each of the one or more failure modes of each of the one or more assets. In an embodiment, the processor 303 may normalize the asset level amplified risk score 315 of each of the one or more failure modes. Further, the processor 303 may determine a weightage for the normalized asset level amplified risk score of each of the one or more failure modes using a first predefined technique. Thereafter, the processor 303 may determine the asset level first score 317 based on the risk score of the one or more failure modes and a cumulative weightage score of the each of the one or more failure modes. The cumulative weightage score is obtained by aggregating weightage of the each of the one or more failure modes.

At block 509, the method 500 includes assessing, by the processor 303, dynamic risk of each of the one or more assets based on the asset level first score 313 and the asset level first score 317. In an embodiment, the processor 303 may determine at least one critical asset among the one or more assets and at least one critical failure mode of the at least one critical asset based on the assessment of each of the one or more assets.

At block 511, the method 500 includes providing, by the processor 303, one or more corrective action recommendations related to the one or more assets based on the assessment.

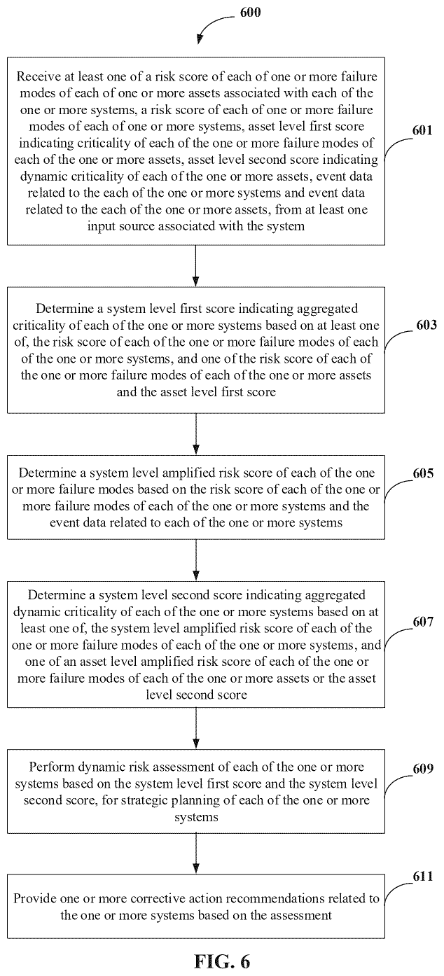

As illustrated in FIG. 6, the method 600 may include one or more blocks illustrating a method of assessing dynamic risk for strategic planning of a system associated with one or more assets using a computing system 101 illustrated in FIG. 4. The method 600 may be described in the general context of computer executable instructions. Generally, computer executable instructions can include routines, programs, objects, components, data structures, procedures, modules, and functions, which perform specific functions or implement specific abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 601, the method 600 includes receiving, by a processor 403 associated with the computing system 101, at least one of a risk score of each of one or more failure modes of each of one or more assets associated with each of the one or more systems, a risk score of each of one or more failure modes of each of one or more systems, asset level first score 313 indicating criticality of each of the one or more failure modes of each of the one or more assets, asset level first score 317 indicating dynamic criticality of each of the one or more assets, event data related to the each of the one or more systems and event data related to the each of the one or more assets, from at least one input source 105 associated with the system. In an embodiment, to determine the asset level first score 313 and the asset level first score 317, the processor 403 may determine the asset level first score 313 based on the risk score of each of the one or more failure modes of each of the one or more assets. Further, the processor 403 determines the asset level amplified risk score 315 of each of the one or more failure modes based on the risk score of each of the one or more failure modes of each of the one or more assets and the event data related to each of the one or more assets. Thereafter, the processor 403 may determine the asset level first score 317 based on the asset level amplified risk score 315 of each of the one or more failure modes of each of the one or more assets. The event data may be generated based on at least one of analytics information related to the system received from analytics data sources, alerts and warnings related to the system received from control systems, and notifications related to the system received from Enterprise Resource Planning (ERP) systems. The event data may indicate at least one of a plurality of characteristics associated with each of one or more events related to corresponding system.

At block 603, the method 600 includes determining, by the processor 403, a system level first score 413 indicating aggregated criticality of each of the one or more systems based on at least one of the risk score of each of the one or more failure modes of each of the one or more systems, and one of the risk score of each of the one or more failure modes of each of the one or more assets and the asset level first score 313. In an embodiment, the processor 403 may normalize the risk score of each of the one or more failure modes of each of the one or more systems and the risk score of each of one or more failure modes of each of the one or more assets. Further, the processor 403 may determine a weightage for the normalized risk score of each of the one or more failure modes of each of the one or more systems and each of one or more failure modes of each of the one or more assets using a first predefined technique. Thereafter, the processor 403 may determine the system level first score 413 based on the risk score of the one or more failure modes and cumulative weightage score of the each of the one or more failure modes of each of the one or more systems and each of one or more failure modes of each of the one or more assets. The cumulative weightage score is obtained by aggregating weightage of the each of the one or more failure modes of each of the one or more systems and each of one or more failure modes of each of the one or more assets.

At block 605, the method 600 includes determining, by the processor 403, a system level amplified risk score 415 of each of the one or more failure modes based on the risk score of each of the one or more failure modes of each of the one or more systems and the event data related to each of the one or more systems. In an embodiment, the processor 403 may determine at least one weightage value for each of the system based on the event data and a plurality of characteristics associated with each of one or more events related to the corresponding system. Further, the processor 403 may determine an amplification factor for each of the one or more failure modes of each of the one or more systems based on the at least one weightage value using a second predefined technique. Thereafter, the processor 403 may determine the system level amplified risk score 415 of each of the one or more failure modes of each of the one or more systems based on the risk score of each of the one or more failure modes of each of the one or more systems and the corresponding amplification factor.

At block 607, the method 600 includes determining, by the processor 403, a system level second score 417 indicating aggregated dynamic criticality of each of the one or more systems based on at least one of, the system level amplified risk score 415 of each of the one or more failure modes of each of the one or more systems, and one of an asset level amplified risk score 315 of each of the one or more failure modes of each of the one or more assets or the asset level first score 317. The asset level amplified risk score 315 is determined based on the risk score of each of the one or more failure modes of each of the one or more assets and the event data related to each of the one or more assets. In an embodiment, the processor 403 may the system level amplified risk score 415 of each of the one or more failure modes of each of the one or more systems and the asset level amplified risk score 315 of each of the one or more failure modes of each of the one or more assets. Further, the processor 403 may determine a weightage for the normalized system level amplified risk score of each of the one or more failure modes of each of the one or more systems and each of the one or more failure modes of each of the one or more assets using a first predefined technique. Thereafter, the processor 403 may determine the system level second score 417 based on the risk score of the one or more failure modes and a cumulative weightage score of the each of the one or more failure modes of the one or more systems and each of the one or more failure modes of each of the one or more assets. The cumulative weightage score is obtained by aggregating weightage of the each of the one or more failure modes of each of the one or more systems and each of the one or more failure modes of each of the one or more assets.

At block 609, the method 600 includes assessing, by the processor 403, dynamic risk of each of the one or more systems based on the system level first score 413 and the system level second score 417. In an embodiment, the processor 403 may determine at least one critical system among the one or more systems, at least one critical asset among the one or more assets and at least one critical failure mode of the at least one critical system and the at least one critical asset, based on the assessment of each of the one or more systems.

At block 611, the method 600 includes providing, by the processor 403, one or more corrective action recommendations related to the one or more systems based on the assessment.

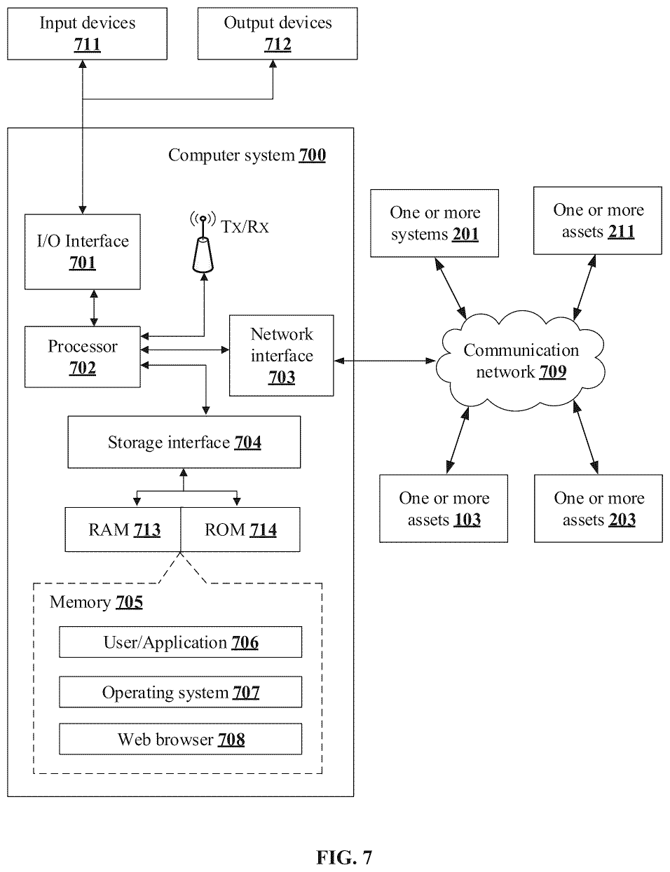

FIG. 7 illustrates a block diagram of an exemplary computer system 700 for implementing embodiments consistent with the present disclosure. In an embodiment, the computer system 700 may be the computing system 101 illustrated in FIG. 1A and FIG. 2A. The computer system 700 may include a central processing unit (“CPU” or “processor” or “memory controller”) 702. The processor 702 may comprise at least one data processor for executing program components for executing user- or system-generated business processes. A user may include a network manager, an application developer, a programmer, an organization or any system/sub-system being operated parallelly to the computer system 700. The processor 702 may include specialized processing units such as integrated system (bus) controllers, memory controllers/memory management control units, floating point units, graphics processing units, digital signal processing units, etc.

The processor 702 may be disposed in communication with one or more Input/Output (I/O) devices (711 and 712) via I/O interface 701. The I/O interface 701 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 701, the computer system 700 may communicate with one or more I/O devices 711 and 712.

In some embodiments, the processor 702 may be disposed in communication with a network 107 via a network interface 703. The network interface 703 may communicate with the network 709. The network interface 703 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In an implementation, the preferred network 709 may be implemented as one of the several types of networks, such as intranet or Local Area Network (LAN) and such within the organization. The preferred network 709 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the network 709 may include a variety of network devices, including routers, bridges, servers, computing devices, storage devices, etc. Using the network interface 703 and the network 709, the computer system 700 may communicate with one or more systems 201 and one or more assets (103, 203, 211).

In some embodiments, the processor 702 may be disposed in communication with a memory 705 (e.g., RAM 713, ROM 714, etc. as shown in FIG. 7) via a storage interface 704. The storage interface 704 may connect to memory 705 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user/application interface 706, an operating system 707, a web browser 708, and the like. In some embodiments, computer system 700 may store user/application data 706, such as the data, variables, records, etc. as described in this invention. Such databases may be implemented as fault-tolerant, relational, scalable, secure databases such as Oracle® or Sybase® or PostgreSQL®.

The operating system 707 may facilitate resource management and operation of the computer system 700. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 706 may facilitate display, execution, interaction, manipulation, or operation of program components through textual or graphical facilities. For example, the user interface 706 may provide computer interaction interface elements on a display system operatively connected to the computer system 700, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 708 may be a hypertext viewing application. Secure web browsing may be provided using Secure Hypertext Transport Protocol (HTTPS), Secure Sockets Layer (SSL), Transport Layer Security (TLS), and the like. The web browsers 708 may utilize facilities such as AJAX, DHTML, ADOBE® FLASH®, JAVASCRIPT®, JAVA®, Application Programming Interfaces (APIs), and the like. Further, the computer system 700 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 700 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In an embodiment, present disclosure assess dynamic risk of assets and systems based on real-time and/or near-real time event data which helps in accurately performing the risk assessment of the assets and the systems.

In an embodiment, present disclosure helps in preventing unexpected equipment failures by proactively identifying change in the criticality of failure modes and taking preventive maintenance actions as the event data is used to determine the asset level second score.

In an embodiment, present disclosure helps in improving the safety by detecting safety-critical failures in advance and taking necessary precautions. Further, the present disclosure helps in proactively identifying the change in the criticality of the failure mode and taking necessary actions to mitigate the failure modes which help in reducing resources and additional cost caused by critical failure modes. In other words, the probable wastage resource and costs which may be incurred if the machine is unfocused is reduced as the present disclosure assess dynamic risk. Efficiently using dynamic FMECA and proactively addressing the criticality will address the environmental impacts that may occur if the failures are met by the assets. The present disclosure may help in extending the lifespan of heavy machinery by using dynamic FMECA.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

| Reference Number | Description |
|---|---|
| 100 | Environment |
| 101 | Computing system |
| 103₁-103_{N} | One or more assets |
| 105 | Input source |
| 201₁-201_{N} | One or more systems |
| 203₁-203_{N} | One or more assets of the system |
| 211₁-211_{N} | One or more assets independent of the system |
| 221 | Fluid power system |
| 223 | Centrifugal compressor |
| 225 | Turbine |
| 227 | Pump |
| 231₁-231_{N} | One or more systems |
| 301 | I/O Interface |
| 303 | Memory |
| 305 | Data |
| 307 | Processor |
| 309 | Modules |
| 311 | Event data related to assets |
| 313 | Asset level first score |
| 315 | Asset level amplified risk score |
| 317 | Asset level second score |
| 319 | Other data |
| 321 | Receiving module of the asset |
| 323 | Determining module of the asset |
| 325 | Assessment module of the asset |
| 329 | Recommendation module of the asset |
| 327 | Other modules of the asset |
| 401 | I/O Interface |
| 403 | Memory |
| 405 | Data |
| 407 | Processor |
| 409 | Modules |
| 411 | Event data related to systems |
| 413 | System level first score |
| 415 | System level amplified risk score |
| 417 | System level second score |
| 419 | Other data |
| 421 | Receiving module of the system |
| 423 | Determining module of the system |
| 425 | Assessment module of the system |
| 429 | Recommendation module of the system |
| 427 | Other modules of the system |
| 700 | Computer system |
| 701 | I/O Interface of the exemplary computer system |
| 702 | Processor of the exemplary computer system |
| 703 | Network interface |
| 704 | Storage interface |
| 705 | Memory of the exemplary computer system |
| 706 | User/Application |
| 707 | Operating system |
| 708 | Web browser |
| 709 | Communication network |
| 711 | Input devices |
| 712 | Output devices |
| 713 | RAM |
| 714 | ROM |

What is claimed is:

1. A method of assessing dynamic risk for strategic planning of one or more assets, the method comprising:
receiving, by a processor associated with a computing system, a risk score of each of one or more failure modes of each of one or more assets and event data related to each of the one or more assets from at least one input source associated with each of the one or more assets;
determining, by the processor, an asset level first score indicating aggregated criticality of each of the one or more assets based on the risk score of each of the one or more failure modes of each of the one or more assets;
determining, by the processor, an asset level amplified risk score of each of the one or more failure modes based on the risk score of each of the one or more failure modes of each of the one or more assets and the event data related to each of the one or more assets;
determining, by the processor, an asset level second score indicating aggregated dynamic criticality of each of the one or more assets based on the asset level amplified risk score of each of the one or more failure modes of each of the one or more assets;
assessing, by the processor, a dynamic risk of each of the one or more assets based on the asset level first score and the asset level second score; and
providing, by the processor, one or more corrective action recommendations related to the one or more assets based on the assessment, and implementing the one or more corrective actions.

2. The method as claimed in claim 1, wherein determining the asset level first score comprises:
normalizing the risk score of each of the one or more failure modes of each of the one or more assets;
determining a weightage for the normalized risk score of each of the one or more failure modes of each of the one or more assets using a first predefined technique; and
determining the asset level first score based on the risk score of the one or more failure modes and cumulative weightage score of the each of the one or more failure modes of each of the one or more assets, wherein the cumulative weightage score is obtained by aggregating weightage of the each of the one or more failure modes of each of the one or more assets.

3. The method as claimed in claim 1, wherein the event data is generated based on at least one of analytics information related to the one or more assets received from analytics data sources, alerts and warnings related to the one or more assets received from control systems, and notifications related to the one or more assets received from Enterprise Resource Planning (ERP) systems, wherein the event data indicates at least one of a plurality of characteristics associated with each of one or more events related to corresponding one or more assets.

4. The method as claimed in claim 1, wherein determining the asset level amplified risk score comprises:
determining at least one weightage value for each of the one or more assets based on the event data and a plurality of characteristics associated with each of one or more events related to the corresponding one or more assets;
determining an amplification factor for each of the one or more failure modes of each of the one or more assets based on the at least one weightage value using a second predefined technique; and
determining the asset level amplified risk score of each of the one or more failure modes of each asset in the one or more assets based on the risk score of each of the one or more failure modes of each of the one or more assets and the corresponding amplification factor.

5. The method as claimed in claim 1, wherein determining the asset level second score comprises:
normalizing the asset level amplified risk score of each of the one or more failure modes;
determining a weightage for the normalized asset level amplified risk score of each of the one or more failure modes using a first predefined technique; and
determining the asset level second score based on the risk score of the one or more failure modes and a cumulative weightage score of the each of the one or more failure modes, wherein the cumulative weightage score is obtained by aggregating weightage of the each of the one or more failure modes.

6. The method as claimed in claim 1, wherein assessing the dynamic risk further comprises determining, by the processor, at least one critical asset among the one or more assets and at least one critical failure mode of the at least one critical asset based on the assessment of each of the one or more assets.

7. A method of assessing dynamic risk for strategic planning of a system associated with one or more assets, the method comprising:
receiving, by a processor, from at least one input source associated with the system, at least one of:
a risk score of each of one or more failure modes of each of one or more assets associated with each of the one or more systems,
a risk score of each of one or more failure modes of each of one or more systems, asset level first score indicating criticality of each of the one or more failure modes of each of the one or more assets,
asset level second score indicating dynamic criticality of each of the one or more assets,
event data related to the each of the one or more systems, and
event data related to the each of the one or more assets;
determining, by the processor, a system level first score indicating aggregated criticality of each of the one or more systems based on at least one of:
the risk score of each of the one or more failure modes of each of the one or more systems, and
one of the risk scores of each of the one or more failure modes of each of the one or more assets and the asset level first score;
determining, by the processor, a system level amplified risk score of each of the one or more failure modes based on the risk score of each of the one or more failure modes of each of the one or more systems and the event data related to each of the one or more systems;
determining, by the processor, a system level second score indicating aggregated dynamic criticality of each of the one or more systems based on at least one of:
the system level amplified risk score of each of the one or more failure modes of each of the one or more systems, and
one of an asset level amplified risk score of each of the one or more failure modes of each of the one or more assets or the asset level second score, wherein the asset level amplified risk score is determined based on the risk score of each of the one or more failure modes of each of the one or more assets and the event data related to each of the one or more assets;
assessing, by the processor, dynamic risk assessment of each of the one or more systems based on the system level first score and the system level second score; and
providing, by the processor, and implementing in the system one or more corrective action recommendations related to the one or more systems based on the assessment.

8. The method as claimed in claim 7, wherein determining the system level first score comprises:
normalizing the risk score of each of the one or more failure modes of each of the one or more systems and the risk score of each of one or more failure modes of each of the one or more assets;
determining a weightage for the normalized risk score of each of the one or more failure modes of each of the one or more systems and each of one or more failure modes of each of the one or more assets using a first predefined technique; and
determining the system level first score based on the risk score of the one or more failure modes and cumulative weightage score of the each of the one or more failure modes of each of the one or more systems and each of one or more failure modes of each of the one or more assets, wherein the cumulative weightage score is obtained by aggregating weightage of the each of the one or more failure modes of each of the one or more systems and each of one or more failure modes of each of the one or more assets.

9. The method as claimed in claim 7, wherein the event data is generated based on at least one of analytics information related to the system received from analytics data sources, alerts and warnings related to the system received from control systems, and notifications related to the system received from Enterprise Resource Planning (ERP) systems, wherein the event data indicates at least one of a plurality of characteristics associated with each of one or more events related to corresponding system.

10. The method as claimed in claim 7, wherein determining the system level amplified risk score comprises:
determining at least one weightage value for each of the system based on the event data and a plurality of characteristics associated with each of one or more events related to the corresponding system;
determining an amplification factor for each of the one or more failure modes of each of the one or more systems based on the at least one weightage value using a second predefined technique; and
determining the system level amplified risk score of each of the one or more failure modes of each of the one or more systems based on the risk score of each of the one or more failure modes of each of the one or more systems and the corresponding amplification factor.

11. The method as claimed in claim 7, wherein determining the system level second score comprises:
normalizing the system level amplified risk score of each of the one or more failure modes of each of the one or more systems and the asset level amplified risk score of each of the one or more failure modes of each of the one or more assets;
determining a weightage for the normalized system level amplified risk score of each of the one or more failure modes of each of the one or more systems and each of the one or more failure modes of each of the one or more assets using a first predefined technique; and
determining the system level second score based on the risk score of the one or more failure modes and a cumulative weightage score of the each of the one or more failure modes of the one or more systems and each of the one or more failure modes of each of the one or more assets, wherein the cumulative weightage score is obtained by aggregating weightage of the each of the one or more failure modes of each of the one or more systems and each of the one or more failure modes of each of the one or more assets.

12. The method as claimed in claim 7, wherein the asset level first score and the asset level second score are determined by:
determining the asset level first score based on the risk score of each of the one or more failure modes of each of the one or more assets;
determining the asset level amplified risk score of each of the one or more failure modes based on the risk score of each of the one or more failure modes of each of the one or more assets and the event data related to each of the one or more assets; and
determining the asset level second score based on the asset level amplified risk score of each of the one or more failure modes of each of the one or more assets.

13. The method as claimed in claim 7, wherein assessing the dynamic risk further comprises determining, by the processor, at least one critical system among the one or more systems, at least one critical asset among the one or more assets and at least one critical failure mode of the at least one critical system and the at least one critical asset, based on the assessment of each of the one or more systems.

14. A computing system for assessing dynamic risk for strategic planning of one or more assets, the computing system comprising:
a processor; and
a memory, communicatively coupled to the processor, wherein the memory stores processor executable instructions, which, on execution, causes the processor to:
receive a risk score of each of one or more failure modes of each of one or more assets and event data related to each of the one or more assets from at least one input source associated with each of the one or more assets;
determine an asset level first score indicating aggregated criticality of each of the one or more assets based on the risk score of each of the one or more failure modes of each of the one or more assets;
determine an asset level amplified risk score of each of the one or more failure modes based on the risk score of each of the one or more failure modes of each of the one or more assets and the event data related to each of the one or more assets;
determine an asset level second score indicating aggregated dynamic criticality of each of the one or more assets based on the asset level amplified risk score of each of the one or more failure modes of each of the one or more assets;
assess a dynamic risk of each of the one or more assets based on the asset level first score and the asset level second score; and
provide one or more corrective action recommendations related to the one or more assets based on the assessment.

15. The computing system as claimed in claim 14, wherein for determining the asset level first score, the processor is configured to:
normalize the risk score of each of the one or more failure modes of each of the one or more assets;
determine a weightage for the normalized risk score of each of the one or more failure modes of each of the one or more assets using a first predefined technique; and
determine the asset level first score based on the risk score of the one or more failure modes and cumulative weightage score of the each of the one or more failure modes of each of the one or more assets, wherein the cumulative weightage score is obtained by aggregating weightage of the each of the one or more failure modes of each of the one or more assets.

16. The computing system as claimed in claim 14, wherein the event data is generated based on at least one of analytics information related to the one or more assets received from analytics data sources, alerts and warnings related to the one or more assets received from control systems, and notifications related to the one or more assets received from Enterprise Resource Planning (ERP) systems, wherein the event data indicates at least one of a plurality of characteristics associated with each of one or more events related to corresponding one or more assets.

17. The computing system as claimed in claim 14, wherein for determining the asset level amplified risk score, the processor may be configured to:
determine at least one weightage value for each of the one or more assets based on the event data and a plurality of characteristics associated with each of one or more events related to the corresponding one or more assets;
determine an amplification factor for each of the one or more failure modes of each of the one or more assets based on the at least one weightage value using a second predefined technique; and
determine the asset level amplified risk score of each of the one or more failure modes of each asset in the one or more assets based on the risk score of each of the one or more failure modes of each of the one or more assets and the corresponding amplification factor.

18. The computing system as claimed in claim 14, wherein for determining the asset level second score, the processor may be configured to:
normalize the asset level amplified risk score of each of the one or more failure modes;
determine a weightage for the normalized asset level amplified risk score of each of the one or more failure modes using a first predefined technique; and
determine the asset level second score based on the risk score of the one or more failure modes and a cumulative weightage score of the each of the one or more failure modes, wherein the cumulative weightage score is obtained by aggregating weightage of the each of the one or more failure modes.

19. The computing system as claimed in claim 14, wherein for assessing the dynamic risk, the processor may be further configured to determine at least one critical asset among the one or more assets and at least one critical failure mode of the at least one critical asset based on the assessment of each of the one or more assets.
